(19) United States
(12) Patent Application Publication
(10) Pub. No.: US 2013/0031579 A1
(43) Pub. Date: Jan. 31, 2013

(54) SYSTEMS AND METHODS FOR SELECTIVELY MODIFYING THE DISPLAY OF ADVERTISEMENTS AND PROVIDING SUPPLEMENTARY MEDIA CONTENT

(71) Applicant: Walter R. Klappert, Los Angeles, CA (US)

(72) Inventor: Walter R. Klappert, Los Angeles, CA (US)

(73) Assignee: UNITED VIDEO PROPERTIES, INC., Santa Clara, CA (US)

(21) Appl. No.: 13/193,350

(22) Filed: Jul. 28, 2011

(51) Int. Cl. H04N 21/458

(52) U.S. Cl. 725/32

(57) ABSTRACT

Systems and methods are provided for selectively suppressing advertisements and providing supplementary media content in place of the advertisements. A program (including program segments and supplementary media content) and advertisements are transmitted to a user device on two different channels. A database may be queried to determine whether the advertisement suppression feature is enabled for a particular user. For example, the user of the user device may subscribe to an advertisement suppression service and an enabled status may be stored in the database. If the status is enabled, the program segments and supplementary media content are provided to the user device without advertisements. If the status is disabled, the program segments and advertisements are provided to the user device without the supplementary media content.

### BACKGROUND OF THE DISCLOSURE

Traditional television broadcasts include programs segments interwoven with commercials provided by advertisers. With the promulgation of consumer electronics, however, viewers of television broadcasts are able to watch television without commercials by recording the program segments on a Digital Video Recorder (DVR) and fast forwarding through the commercials during playback.

Although beneficial to viewers who wish to watch television programs without commercials, such systems are detrimental to advertisers and the television service providers who provide television programming. In particular, as less viewers watch commercials, advertisers are willing to pay less for the commercials and the service providers receive less revenue.

### SUMMARY OF THE DISCLOSURE

The present disclosure presents a system where viewers can continue to watch programs without advertisements while providing service providers with a way to generate the revenue necessary to offset the lower revenue from advertisers. Specifically, viewers can sign up for an advertisement suppression service that allows the viewers to skip advertisements during broadcast programs. Once signed up, the viewers' equipment will tune to broadcast channels that do not include advertisements. These program channels can include extra premium content as an added incentive for viewers to sign up for the suppression service. For the viewers who are not signed up for the service, their equipment will intermix the programs from the channels that do not have advertisements with advertisements from a dedicated advertisement channel.

The disclosure also presents a system where viewers can skip advertisements by playing games that are associated with the advertisements they are watching. Often, the games will have content that relates to the product being advertised. If a viewer wins the game (e.g., answers a question regarding the product being advertised correctly) before the advertisement is complete, the advertiser can reward the viewer by skipping the rest of the advertisement or providing premium content in place of the remainder of the advertisement. These games can also allow viewers to accumulate credits that can be used later to skip future advertisements. By allowing the viewers interact with the advertisements in a fun gaming environment, the viewers are more likely to remember products being advertised.

In particular, systems and methods for selectively modifying the display of advertisements are provided in accordance with various embodiments of the present disclosure. The systems and methods disclosed herein are directed towards managing the display of advertisements in a manner that is beneficial to users (e.g., viewers), advertisers, and service providers.

In some embodiments, systems and methods are provided for selectively skipping advertisements when a user has subscribed to an advertisement suppression service. The user's equipment may receive a program (organized as a series of program segments) and supplementary media content on, for example, a broadcast channel. The user's equipment may also receive advertisements on, for example, a different broadcast channel. The received advertisements may be associated with the received program. For example, one or more of the advertisements may be scheduled for display between each of the program segments.

In some embodiments, a determination may be made regarding whether the user has enabled or disabled an advertisement suppression feature. The user may have enabled an advertisement suppression feature by, for example, subscribing to an advertisement suppression service offered by a broadcast service provider. The user may have disabled an advertisement suppression feature by, for example, not subscribing to an advertisement suppression service or by allowing the user's advertisement suppression service subscription to expire.

In some embodiments, the user's equipment may display the program segments without displaying the advertisements in response to determining that the advertisement suppression feature is enabled. In some embodiments, supplementary media content, such as premium or exclusive content, may be provided in place of the skipped advertisements.

In some embodiments, the user's equipment may display the program segments and the advertisements in response to determining that the advertisement suppression feature is disabled. For example, the user's equipment may record the program segments using one tuner and tune to the advertisements channel using an additional tuner. The user's equipment may play the program segments from their recordings and play the advertisements from the advertisements channel in between each of the program segments.

The systems and methods described herein address the drawbacks of existing systems as described above, and provide a number of additional beneficial features. Users are readily able to view the programs without advertisements by enabling an advertisement suppression feature or service. Users are also able to enhance their viewing experience by gaining access to supplementary media content that is provided in place of the skipped advertisements. Advertisers are able to provide advertisements to users when the user chooses not to enable the advertisement suppression feature or service. Service providers enjoy the benefits of increased user demand for media content and increased revenues from users who are attracted by the advertisement modification system.

In some embodiments, systems and methods are provided for selectively modifying the display of advertisements based on game play in an interactive gaming environment associated with the advertisement. The user's equipment may receive an advertisement associated with a program and display the advertisement. The user's equipment may also initiate an interactive gaming environment associated with the advertisement. The interactive gaming environment may be displayed, for example, as a foreground overlay display screen displayed over the displayed advertisement, as a separate display region displayed alongside the displayed advertisement, or as a new display screen displayed in place of the advertisement.

In some embodiments, the user's equipment may receive an action relating to game play in the interactive gaming environment. For example, the user may guess the product the advertisement is for, shoot at targets of advertising logos, or navigate a racing car through a track covered with poster and billboard advertisements. When the user successfully completes the requirements of the game play, the user's equipment may modify the display of the advertisement. For example, the user's equipment may modify the display of the advertisement by skipping or fast forwarding through the remainder of the displayed advertisement. In some embodiments, supplementary media content, such as premium or exclusive content, may be provided in place of the skipped advertisement.

In some embodiments, an advertisement modification credit may be associated with the user who provided the action relating to the game play. Advertisement modification credits may be used to modify the display of future advertisements. For example, the user may be awarded an advertisement modification credit for successfully completing the game play in the interactive gaming environment. The number of advertisement modification credits associated with the user is updated to reflect the awarded advertisement modification credit (e.g., by adding the new advertisement modification credit to the total number of advertisement modification credits associated with the user).

In some embodiments, the amount of advertisement modification credits associated with the user may be compared with an advertisement modification threshold value (e.g., the number of advertisement modification credits required to modify an advertisement). If the amount of advertisement modification credits is greater than or equal to the advertisement modification threshold value, the display of the advertisement is modified. If the amount of advertisement modification credits is less than the advertisement modification threshold value, the display of the advertisement is continued.

The systems and methods described herein address the drawbacks of existing systems as described above, and provide a number of additional beneficial features. Users are readily able to view the programs with fewer advertisements by successfully completing game play in an interactive gaming environment. Users are also able to enhance their viewing experience by gaining access to supplementary media content that is provided in place of the skipped advertisements. Users may even be rewarded with credits for their participation in the interactive gaming environments, which are accumulated for use in skipping future advertisements. Advertisers are able to provide users with advertisements and interactive gaming environments associated with the advertisements. The interactive gaming environments may increase the user's recognition of the advertiser's products and retention of the advertiser's message by requiring user participation. Service providers enjoy the benefits of increased user demand for media content and increased revenues from users who are attracted by the advertisement modification system.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an example of a system for modifying the display of advertisements in accordance with some embodiments of the present disclosure;

FIG. 2 illustrates an example of a user equipment device in accordance with some embodiments of the present disclosure;

FIG. 3 illustrates an exemplary data transmission technique for selectively modifying advertisements and providing supplementary media content to fill a specified time of programming in accordance with some embodiments of the present disclosure;

FIG. 4 illustrates another exemplary data transmission technique for selectively modifying advertisements and providing supplementary media content to fill a specified time of programming in accordance with some embodiments of the present disclosure;

FIG. 5 illustrates another exemplary data transmission technique for selectively modifying advertisements and providing supplementary media content to fill a specified time of programming in accordance with some embodiments of the present disclosure;

FIG. 6 shows an illustrative interactive gaming environment display for use in selectively modifying the display of an advertisement in accordance with some embodiments of the present disclosure;

FIG. 7 shows another illustrative interactive gaming environment display for use in selectively modifying the display of an advertisement in accordance with some embodiments of the present disclosure;

FIG. 8 shows another illustrative interactive gaming environment display for use in selectively modifying the display of an advertisement in accordance with some embodiments of the present disclosure;

FIG. 9 illustrates an exemplary data transmission technique for selectively modifying the display of an advertisement in accordance with some embodiments of the present disclosure;

FIG. 10 is a flow chart of illustrative steps involved in selectively suppressing advertisements and providing supplementary media content in accordance with some embodiments of the present disclosure;

FIG. 11 is a flow chart of illustrative steps involved in selectively modifying the display of advertisements in accordance with some embodiments of the present disclosure; and

FIG. 12 is a flow chart of illustrative steps involved in associating advertisement modification credits with user actions for selectively modifying the display of advertisements in accordance with some embodiments of the present disclosure.

### DETAILED DESCRIPTION

The present disclosure is directed towards systems and methods for providing advertisements which may be selectively modified by a user. Advertisement modification refers to, for example, skipping an advertisement, skipping all advertisements in a group of advertisements, skipping all advertisements scheduled for display between two program segments (e.g., act 1 and act 2), suppressing an advertisement, fast forwarding through an advertisement, abstaining from receiving or retrieving an advertisement, displaying an advertisement different from the displayed advertisement, displaying supplementary media content, providing an interactive gaming environment different from the interactive gaming environment associated with the displayed advertisement (e.g., an entertaining video game that is not associated with an advertisement), performing any other suitable action, or any suitable combination. The term “user” refers to the person, player, or viewer performing a particular action or interacting with the interactive gaming environment (e.g., transmitting an answer to a question provided during game play of the interactive gaming environment). The term “advertisement modification” may be referred to herein as “advertisement suppression.”

In some embodiments, the user may modify the display of advertisements by subscribing to an advertisement suppression service (e.g., as a cable subscription product) to view television programs without advertisements. For example, the display of advertisements may be suppressed if the user's advertisement suppression status is enabled (e.g., the user is subscribed to an advertisement-free cable broadcast service).

In some embodiments, supplementary media content may be provided to fill a specified time of programming corresponding to the amount of time created by the skipped advertisements. Supplementary media content may include, for example, premium media content such as extras, interviews, “making of” segments, pay-per-view media assets, media on-demand assets, television programming, Internet content, or other suitable information. For example, a sixty minute television program may include sixteen minutes of advertisements. When the advertisements are skipped, sixteen minutes of supplementary content may be provided to the user in place of the skipped advertisements to fill the scheduled sixty minutes of programming. For example, a user may be provided with the forty-four minute, advertisement-free portion of a sixty minute program scheduled for display from 8:00 am to 9:00 am. The user may then be provided with twenty minutes of a “behind-the-scenes” documentary (e.g., from 8:44 am to 9:00 am) in place of the sixteen minutes of skipped advertisements associated with the sixty minute program. In some embodiments, the supplementary media content may be provided in between the program segments to coincide with the scheduled display of the advertisements. For example, a user may be provided with supplementary media content in place of scheduled breaks for advertisements while the user is watching, for example, a live broadcast.

In some embodiments, advertisement suppression may be implemented by separating programming and advertising into separate channels and/or providing programs and advertisements on separate channels. For example, program segments and supplementary media content may be provided on a programming channel while advertisements are provided on a separate advertisements channel. If the user's advertisement suppression status is enabled, the user's viewing equipment (e.g., television, personal computer, tablet computer, mobile phone) may tune to the programming channel to display the program segments and supplementary media content without tuning to the advertisements channel. If the user's advertisement suppression status is not enabled, the user's viewing equipment may tune to the programming channel to display the first program segment. When the first program segment has ended (e.g., as determined by broadcast timing information), the user's viewing equipment may tune to the advertisements channel to display the first advertisement. A recording device, such as the user's DVR, may be used to record the second program segment while the first advertisement is being displayed. When the first advertisement has ended, the user's viewing equipment may play the recording of the second program segment from the recording device.

In some embodiments, the user may modify the display of an advertisement by playing a game associated with the advertisement provided by an interactive gaming environment. An interactive gaming environment is an entertainment application that is used by users to modify the display of an advertisement. The interactive gaming environment may be provided in whole or in part at home on a television or personal computer, on a mobile computing device that can execute software applications, a mobile phone, and as a handheld portable game. The interactive gaming environment is made up of a program or software that instructs processing circuitry to display specific visual and audio effects and receive various inputs/responses from a user. Interactive gaming environment may be referred to above and below interchangeably with interactive gaming environment, video game, electronic gaming environment, electronic interactive gaming environment, electronic interactive video gaming environment, electronic interactive video game, media guidance application, media gaming environment, interactive media gaming environment, interactive game, or any combination thereof.

In some embodiments, the interactive gaming environment may be implemented as an application on a television, user viewing equipment, or any other suitable media equipment device. Applications are collections of instructions executable by a processor that provide information from the Internet and/or otherwise remotely accessible servers (hereinafter “remote servers”) to a user. A application may provide this information through web services and/or using any suitable communication protocol (e.g., TCP/IP, IPTV, etc.). Applications may also perform local processing tasks, such as guiding a user through the interactive gaming environment, receiving user actions or user inputs, and modifying the display of advertisements.

In some embodiments, the display of the advertisement may be modified when the user successfully completes the game play in the interactive gaming environment associated with the advertisement. In an example, the user may successfully complete game play when the user selects the correct answer (e.g., the product the advertisement is for) from a multiple choice list in an interactive question-and-answer gaming environment. In another example, the user may successfully complete game play when the user shoots all of the targets (e.g., icons, logos, and/or videos of the advertiser's products) in an interactive shooting gaming environment. In another example, the user may successfully complete game play when the user surpasses the scoring threshold for a racing game that includes poster and billboard advertisements (e.g., icons, logos, and/or videos of the advertiser's products) in an interactive racing gaming environment.

In some embodiments, the user's viewing equipment may modify the display of the advertisement associated with the interactive gaming environment by skipping or fast forwarding through the advertisement. In some embodiments, the user's equipment may display programming content, supplementary media content, or another advertisement when the user successfully completes the game play in the interactive gaming environment associated with the advertisement. For example, the user may be provided with the next segment of a program in response to shooting all of the targets during game play, or by shooting a certain number of targets within an amount of time specified by the game. In another example, when the user provides the correct answer during game play, the user may be rewarded with an actor interview for the remaining duration of the skipped advertisement. In some embodiments, supplementary media content may be provided to the user at the end of the program to fill the specified time of programming. For example, a user may fast forward through fifteen minutes of a scheduled twenty minutes of advertisements during a forty minute program scheduled for display during a specified sixty minutes of programming (e.g., 7:00 pm to 8:00 pm). The user may be provided with fifteen minutes of supplementary content at the end of the program (e.g., from 7:45 pm to 8:00 pm) to fill the specified sixty minutes of programming.

In some embodiments, the advertisement, the interactive gaming environment, or both may be targeted to a particular user based on demographic information, monitored information, or both. For example, the advertisement may be targeted for a predetermined demographic group (e.g., ages 12-17 located in California). Systems and methods for providing targeted advertisements are discussed in greater detail in connection with Alexander et al., U.S. Pat. No. 6,177,931, issued Jan. 23, 2001, which is hereby incorporated by reference herein in its entirety.

In some embodiments, the difficulty or complexity of the interactive gaming environment may be targeted to a particular user. For example, a simple interactive racing environment may be associated with an advertisement for a children's product. In another example, a complex, shooting-type action gaming environment may be associated with an advertisement displayed during a program targeted to the 18-22 year old male demographic. In another example, an interactive question-and-answer gaming environment may be associated with an advertisement targeted to the 65 year old and older demographic.

In some embodiments, the level of difficulty of the interactive gaming environment may increase as the user successfully completes each game play. For example, the interactive shooting gaming environment associated with an initial advertisement may require the user to shoot five advertiser logos to successfully complete the game play, while the interactive shooting gaming environment associated with a later advertisement may require the same user to shoot ten advertiser logos to successfully complete the game play.

In some embodiments, the user may select a preferred gaming environment. For example, a user may select the interactive shooting gaming environment as the preferred gaming environment. In some embodiments, the user's behavior may be monitored to determine a preferred interactive gaming environment. For example, an interactive racing gaming environment may be determined to be a preferred interactive gaming environment based on the user successfully completing interactive racing games more than any other gaming type. The preferred gaming environment may be stored in the user's profile for use in providing interactive gaming environments associated with future advertisements.

In some embodiments, an advertisement modification credit may be awarded to the user when the user succeeds in the interactive game play. An advertisement modification credit may be any suitable value (e.g., 1, 0.45, 572) for use in modifying the display of a currently displayed advertisement or the display of a future advertisement. For example, the user may be awarded an advertisement modification credit (e.g., +1 credit) when the user provides a correct answer in the interactive gaming environment.

In some embodiments, advertisement modification credits may associated with a user, user profile, or user device and stored in any suitable storage location (e.g., the user device or a remote server coupled to the user device). In some embodiments, advertisement modification credits may be accumulated in response to successful completion of game play in multiple interactive gaming environments. For example, a user who has eight advertisement modification credits associated with the user's profile or the user's device may be awarded one credit for successfully completing game play in an interactive gaming environment. Accordingly, the number of the user's advertisement modification credits may be updated to nine advertisement modification credits.

In some embodiments, advertisement modification credits may be used to modify the display of an advertisement. For example, the number of user advertisement modification credits and may be compared to a predetermined number of advertisement modification credits required to modify the display of a particular advertisement (e.g., the advertisement modification credit threshold value). If the user's advertisement modification credits are less than the advertisement modification credit threshold value (e.g., the user has two advertisement modification credits and the advertisement modification credit threshold value is three credits), the advertisement may be displayed. If the user's advertisement modification credits are equal to or greater than the advertisement modification credit threshold value (e.g., the user has three advertisement modification credits and the advertisement modification credit threshold value is three credits), the display of the advertisement may be modified using the user's advertisement modification credits. The user's profile may be updated by subtracting the number of advertisement modification credits used to modify the display of the advertisement. In the example, the user's profile may be updated to reflect zero advertisement modification credits by subtracting three advertisement modification credits.

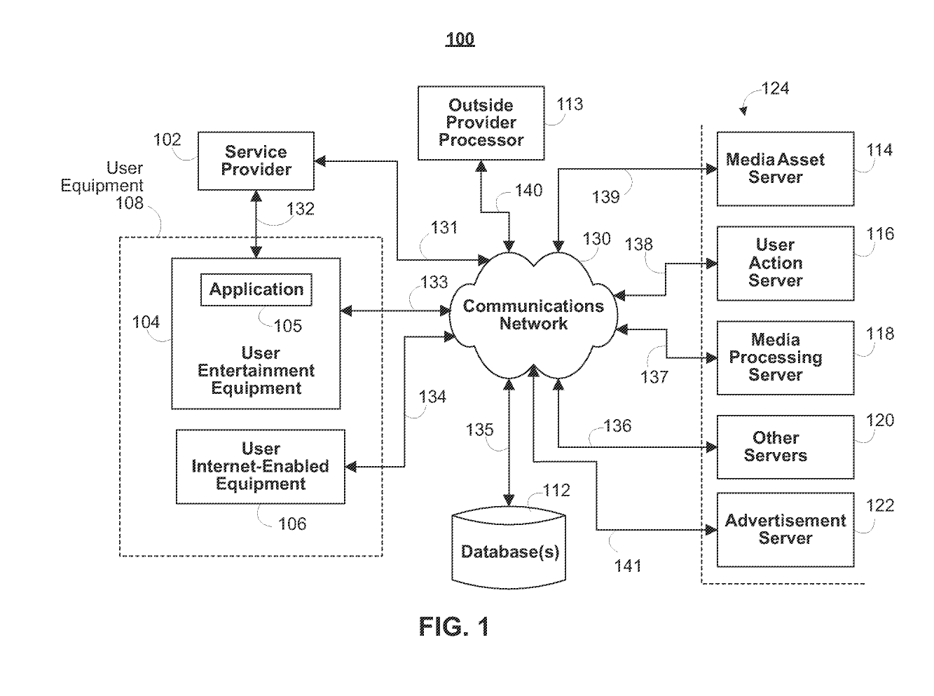

FIG. 1 illustrates an example of a system 100 for providing advertisement management capabilities. It will be appreciated that the features described in this disclosure may be performed by any suitable arrangement of components, which may or may not be shown in FIG. 1. It will also be appreciated that some or all of the features described in this disclosure may be performed by user equipment 108.

In some embodiments, one or more components of system 100 may provide media content and advertisements to a user. For example, service provider 102 may provide television programs and advertisements to user equipment 108.

In some embodiments, one or more components of system 100 may modify some or all of the advertisements based on the status of an advertisement suppression feature. For example, outside provider processor 113 and application 105 may direct user equipment 108 to skip advertisements in response to determining that the user profile in database 112 indicates that the user is subscribed to an advertisement suppression service. In some embodiments, one or more components of system 100 may provide supplementary media content to fill a specified amount of time created by the modification of an advertisement. For example, outside provider processor 113 and application 105 may direct user equipment 108 to display supplementary media content in place of skipped advertisements.

In some embodiments, one or more components of system 100 may provide an interactive gaming environment that allows a user to modify the display of an advertisement. For example, outside provider processor 113 and application 105 may provide user equipment 108 with an interactive gaming environment that is associated with an advertisement transmitted to user equipment 108 from service provider 102.

In some embodiments, one or more components of system 100 may award a user with advertisement modification credits in response to successfully completing the game play. For example, outside provider processor 113 and application 105 may determine whether or not to award an advertisement modification credit to a user based on a user action provided at user equipment 108. In some embodiments, one or more components of system 100 may modify the display of an advertisement based on the number of advertisement modification credits associated with a user or with user equipment 108. For example, outside provider processor 113 and application 105 may skip and advertisement and subtract the number of advertisement modification credits used to modify the advertisements from the number of credits associated with the user profile or user equipment 108.

System 100 includes user equipment 108, which may include application 105, user entertainment equipment 104, and user internet-enabled equipment 106. Application 105 may be resident in user entertainment equipment 104 within user equipment 108. Alternatively, application 105 may be resident in user internet-enabled equipment 106 within user equipment 108. User equipment 108 may include both user entertainment equipment 104 and user internet-enabled equipment 106.

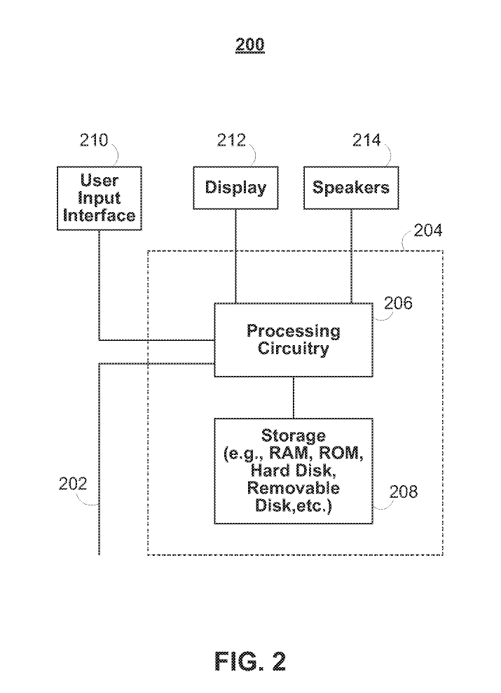

Application 105 may be a software application that is downloaded or installed, for instance, in user entertainment equipment 104. For example, application 105 may be an application (i.e., collections of instructions executable by a processor) that provide information from the Internet and/or otherwise remotely accessible servers (hereinafter “remote servers”) to a user through web services and/or using any suitable communication protocol (e.g., TCP/IP, IPTV, etc.). Application 105 may also perform local processing tasks, such as guiding a user through the interactive gaming environment, receiving user actions or user inputs, and providing and/or displaying media content, supplementary media content, and advertisements to the user. Application 105 may be executed by an interpreter or virtual machine running, for example, on control circuitry of user entertainment equipment 104 (e.g., control circuitry 204 of FIG. 2). Application 105 may allow users to interact with web services while watching television, media assets or other media asset or program on user entertainment equipment 104. In some embodiments, application 105 may run on the Yahoo! Connected TV platform, and user entertainment equipment 104 may be a television manufactured with built-in support for application 105. YAHOO! is a registered trademark owned by Yahoo! Inc. It will be understood that the term application is inclusive of television applications and other applications with application-type functionality. For example, application 105 may include a JAVA applet executable on a mobile device or any other software application executable on the mobile device (e.g., iPhone application or Android application). JAVA is a registered trademark owned by Sun Microsystems, Inc. IPHONE is a registered trademark owned by Apple Inc. ANDROID is a registered trademark owned by Google Inc. In some implementations, application 105 may be downloaded or received from a remote server to the mobile device over an open market for free or for a fee from an application store (e.g., marketplace or app store) which is hosted by a remote server.

In some embodiments, application 105 may be packaged and/or encoded in the ETV Binary Interchange Format (EBIF), received by control circuitry 204 of FIG. 2 as part of a suitable feed, and interpreted by a user agent running on control circuitry 204. For example, application 105 may be an EBIF application and user entertainment equipment 104 may be a set-top box. In other embodiments, the application may be defined by a series of JAVA-based files that are received and run by a local virtual machine or other suitable middleware executed by control circuitry 204 of FIG. 2. In yet other embodiments (e.g., those employing MPEG-2 or other digital media encoding schemes), the application may be encoded and transmitted in an MPEG-2 object carousel with the MPEG audio and video packets of a program. In this embodiment, application 105 may be an OCAP application (e.g., a tru2way application), and user entertainment equipment 104 may be a set-top box.

In other embodiments, user entertainment equipment 104 may include user television equipment, user computer equipment, a wireless user communication device, an e-reader, a set-top box, an iPad, a touch screen tablet device, a media equipment device, a mobile telephone, or any other type of user entertainment equipment for accessing media, such as a non-portable or portable gaming machine. IPAD is a registered trademark owned by Apple Inc.

User internet-enabled equipment 106 may include a set-top box, an integrated receiver decoder (IRD) for handling satellite television, a PC, a laptop, a tablet, an e-reader, an XBOX gaming console (e.g., XBOX 360 with Kinect), a personal computer television (PC/TV), a PC media server, a PC media center, an iPad, a touch screen tablet device, a mobile telephone, a mobile entertainment device, a media equipment device, a television set, a digital storage device, a DVD recorder, a Blu-ray Disc Player, a local media server, wireless user communications devices, portable exercise equipment, stand-alone exercise equipment or any other suitable internet-enabled or non-internet-enabled equipment. XBOX, XBOX 360, and KINECT are registered trademarks owned by Microsoft Corporation. Wireless communications devices may include a personal digital assistant (PDA), a mobile telephone, a smartphone, a portable music user, a portable gaming machine, an iPad, a touch screen tablet device, or other wireless devices.

In some embodiments, user profile information may be associated with user equipment 108 and/or the user of user equipment 108. User profile information can include, for example, user equipment identification information, user identification information, user login information, user advertisement suppression information (e.g., advertisement suppression subscription status, level of an advertisement suppression subscription), user advertisement modification information (e.g., the number of advertisement modification credits associated with the user or user equipment 108), user permissions information, interactive gaming environment preferences, media favorites, media guidance settings, display preferences, and any other suitable settings. User profile information may be stored in a remote data store (e.g., one of databases 112), in a data store within user equipment 108 (e.g., storage 208 of FIG. 2), or both.

In system 100, there is typically more than one user equipment 108 but only one is shown in FIG. 1 to avoid overcomplicating the drawing. In addition, the user may utilize more than one type of user equipment 108 (e.g., the user may have a television set and a computer) and also more than one of each type of user equipment 108 (e.g., the user may have a PDA and a mobile telephone and/or multiple television sets).

It should be noted that, with the advent of television tuner cards for PC's, WebTV, and the integration of video into other user equipment devices, the lines have become blurred when trying to classify a device as user entertainment equipment 104 or user internet-enabled equipment 106. In fact, in certain embodiments, application 105 may run on user internet-enabled equipment 106 in addition to user entertainment equipment 104, and settings information may be entered using either type of user equipment. Each of user equipment 108 may utilize at least some of the system features described below with respect to FIG. 2 and, as a result, include flexibility with respect to the type of interactive applications available on the device. For example, user entertainment equipment 104 may be internet-enabled allowing for access to settings information through the Internet, while user internet-enabled equipment 106 may include a tuner allowing for access to television programming, and both may run application 105 together or separately. It should therefore be understood that, in some embodiments, user entertainment equipment 104 and user internet-enabled equipment 106 are integrated components of a single user device (i.e., user equipment 108).

Application 105 may have the same display layout and/or execution parameters on the various types of user equipment or may be tailored to the display and/or processing capabilities of the user equipment. For example, on user entertainment equipment 104, application 105 may run as a persistent (e.g., always-running) application. In another example, the application display screens may be scaled down for wireless user communications devices.

In addition to application 105, user equipment 108 may access and/or run a media guidance application that provides an interface that allows users to efficiently navigate through media selections and easily identify media content that they may desire. Media guidance applications may take various forms depending on the media for which they provide guidance. One typical type of media guidance application is an interactive television program guide or interactive media guide. Interactive television program guides (sometimes referred to as electronic program guides or EPGs) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), recorded programs, and other types of media content (e.g., audio content). Moreover, media guidance applications allow users to navigate among and locate content related to the media content for which guidance is provided including, for example, video clips, audio assets, articles, advertisements, chat sessions, games, etc. Media guidance applications may be provided as on-line applications (i.e., provided on a web-site), or as stand-alone applications or clients.

The aforementioned settings information entered by the user may be consistent across in-home devices and remote devices. For example, if the user sets a channel as a favorite on, for example, the web site www.tvguide.com on their personal computer at their office, the same channel would appear as a favorite on the user's in-home devices (e.g., in a media guidance application running on user entertainment equipment 104). Therefore, changes in settings made on one user equipment device can change the user's experience on another user equipment device, regardless of whether they are the same or a different type of user equipment device. In addition, the changes made may be based on settings input by the user, as well as monitored user activity (e.g., activity monitored by application 105).

In some embodiments, user profile information may include data from monitoring a user's activity. For example, user interaction with application 105, a media guidance application, and/or any other suitable application or feature (e.g., running on or displayed by user equipment 108) may be monitored and recorded. User profile information may also include user-identifying information (e.g., the user's name), user viewing habits, user demographic information, user advertisement suppression subscription information, user interactive video gaming information (e.g., user advertisement modification credits), or any other suitable data relating to and/or describing the user. User profile information may be stored within user equipment 108 and/or at a remote location (e.g., databases 112).

The user equipment devices of user equipment 108 may be coupled to communications network 130. Namely, user entertainment equipment 104 and user internet-enabled equipment 106 may be coupled to communications network 130 using communications paths 133 and 134, respectively. Communications network 130 may be one or more networks including a local area network, a wide area network, the Internet, a mobile phone network, peer-to-peer network, mobile device (e.g., Blackberry) network, cable network, public switched telephone network, or other types of communications networks. BLACKBERRY is a service mark owned by Research In Motion Limited, Corp. Paths 131-141 may separately or together include one or more communications paths, such as a satellite path, a fiber-optic path, a cable path, a path that supports Internet communications (e.g., TCP/IP, IPTV, etc.), peer-to-peer connections, free-space connections (e.g., for broadcast or other wireless signals), or any other suitable wired or wireless communications path or combination of such paths. Communications with user equipment 108 may be provided by one or more of these communications paths, but are shown as single paths in FIG. 1 to avoid overcomplicating the drawing. Communications between multiple user equipment 108 may be provided by one or more of these communications paths, but are shown as single paths in FIG. 1 to avoid overcomplicating the drawing or may be handled through an intermediate source, such as outside provider processor 113.

Although communications paths are not drawn between various user equipment 108 (e.g., between user entertainment equipment 104 and user internet-enabled equipment 106), these devices may communicate directly with each other through communications network 130 and/or via short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. User equipment 108 may also communicate with each other indirectly, e.g., through an indirect path via communications network 130.

In some embodiments, application 105 is invoked expressly by the user, for instance, in response to an indication or selection received from the user (e.g., via user input interface 210 of FIG. 2). In other embodiments, application 105 is invoked automatically, for example, upon selection or display of an advertisement or request to access or use the interactive gaming environment.

In response to invocation, application 105 may send information to service provider 102 over communications link 132, outside provider processor 113 (hereinafter “outside provider processor 113”) over communications network 130 (including, e.g., paths 133 and 140), or both. In some embodiments, communications with service provider 102 and outside provider processor 113 may be exchanged over one or more communications paths, but are shown as two separate paths in FIG. 1 to avoid overcomplicating the drawing. In addition, there may be more than one of each of service provider 102 and outside provider processor 113, but only one of each is shown in FIG. 1 to avoid overcomplicating the drawing. In some embodiments, service provider 102, outside provider processor 113, database 112, media asset server 114, advertisement server 122, and any other suitable component may part of the same component, structure, or facility. The information that application 105 sends to these sources may include settings information, an identification number, a status of an advertisement suppression feature (e.g., a level of an advertisement suppression subscription), an indication of the channel or media asset the user is watching, and/or an indication of a particular interactive gaming environment or action in the interactive gaming environment selected by the user.

Service provider 102 may include one or more types of media distribution equipment including a television distribution facility, cable system head-end, satellite distribution facility, programming sources (e.g., television broadcasters, such as NBC, ABC, HBO, etc.), intermediate distribution facilities and/or servers, Internet providers, on-demand media servers, and other media content providers. NBC is a registered trademark owned by NBC Universal Media, LLC. ABC is a registered trademark owned by American Broadcasting Companies, Inc. HBO is a registered trademark owned by Home Box Office, Inc. Service provider 102 may be the originator of media content, e.g., a television or internet broadcaster, a Webcast or streaming video provider, a digital cable service provider, a bundled communication (e.g., Internet, telephone, and TV) provider such as Verizon FiOS, a provider of digital on-demand media, a cellular telephone service provider, etc. VERIZON and FIOS are registered trademarks owned by Verizon Communications Inc. Alternatively, service provider 102 may not be the originator of media content, e.g., an on-demand media content provider, an Internet provider of video content of broadcast programs for downloading or streaming, etc.

Service provider 102 may include cable sources, satellite providers, on-demand providers, Internet providers, or other providers of media content or interactive gaming environment. Service provider 102 may also include a remote media server used to store different types of media content, including video content selected by a user, for example, on a website. In some embodiments, service provider 102 may be the central source from which information pertaining to the interactive gaming environment is received by application 105 or user equipment 108. For example, service provider 102 (e.g., application store) may store the program code (e.g., the application or app) for executing the interactive gaming environment on a particular user equipment 108. The program code for executing the interactive gaming environment on a mobile phone, for example, may be a less complex version of the interactive gaming environment provided to an internet-enabled television set. The user may be required to purchase the program code to download and access the interactive gaming environment on user equipment 108.

As used herein, the term broadcaster may refer to an analog or digital signal provider, a cable network, a satellite provider, an Internet website, a cellular telephone network provider, an Internet content provider, or any such provider that may distribute media content such as media assets or interactive gaming environment information to user equipment 108. As used herein, the terms broadcaster's website or media broadcaster's website may refer to one or many web addresses, server addresses, databases, or other sources of media information or media content, specific to a particular broadcaster, and associated with Internet websites or other content providers. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Service provider 102 may also provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips or segments, etc.), on-demand information, and any other type of guidance data that is helpful for a user to navigate among and locate desired media asset selections.

In some embodiments, service provider 102 may provide media content and advertisements to user equipment 108 on separate channels. For example, service provider 102 may provide a program consisting of multiple program segments and a supplementary program segment that includes supplementary media content on a first channel. Service provider 102 may provide advertisements on a second channel, such as an advertisements channel. User equipment 108 may include multiple tuners to tune to the program and the advertisements.

Outside provider processor 113 may include a data processor (e.g., any suitable computer server equipment) operated by an outside provider (e.g., the provider of application 105) that can act as a central hub for communications between application 105 running on user equipment 108, service provider 102, various user equipments 108 and third party servers 124. As will be discussed, third party servers 124 may include media asset server 114, user action server 116, media processing server 118, advertisement server 122, and other servers 120. In some embodiments, media asset server 114, user action server 116, media processing server 118, advertisement server 122 or other servers 120 may respond to requests from outside provider processor 113 to process user actions and/or receive and store media assets and advertisements.

In some embodiments, outside provider processor 113 may store and retrieve information from databases 112. Databases 112 may be any suitable computer server equipment and/or any suitable data storage device. Although outside provider processor 113, service provider 102, databases 112 and servers 124 are drawn separately, they may all be housed in a single device at a single geographical location, multiple devices at the same or different geographical locations and/or on a single integrated circuit coupled to communications network 130.

In some embodiments, outside provider processor 113 may act as a clearinghouse of information for providing data and/or other interactive features to the user of application 105. To achieve this function, outside provider processor 113 may exchange information with third party servers 124 via communications network 130 and/or communication links 136-140. For example, outside provider processor 113 may receive a media asset from media asset server 114 and provide the media asset to user equipment 108 via communication network 130. Alternatively, user equipment 108 may receive the media asset directly from media asset server 114. As another example, outside provider processor 113 may transmit a request for a media asset or a portion of a media asset (e.g., a specific frame of the media asset) to media asset server 114. Media asset server 114 may fulfill the request by providing the media asset or portion of the media asset to the outside provider processor 113 via communications network 130. Alternatively, media asset server 114 may fulfill the request by providing the media asset or portion of the media asset to the outside provider processor 113 from databases 112 via communications network 130.

In some embodiments, outside provider processor 113 may retrieve settings information, such as user advertisement suppression information, from any suitable source. In particular, outside provider processor 113 may retrieve from databases 112 the user advertisement suppression subscription status. If an advertisement suppression feature is enabled (e.g., the user is subscribed to an advertisement suppression service), outside provider processor 113 may direct user equipment 108 to display programming content without advertisements (e.g., by not tuning to an advertisements channel), display supplementary media content (e.g., in place of advertisements or at the end of the program to fill a specified time of programming), perform any other suitable action, or any suitable combination. If an advertisement suppression feature is disabled (e.g., the user is not subscribed to an advertisement suppression service or the user's subscription has expired), outside provider processor 113 may direct user equipment 108 to display advertisements by tuning to an advertisements channel at the end of a program segment (e.g., at an advertising break), may not provide supplementary media content, perform any other suitable action, or any suitable combination. In certain embodiments, intermediate advertisement suppression status levels may exist. For example, a partially enabled status may allow user equipment 108 to suppress (e.g., by not tuning to an advertisements channel) a portion of the advertisements scheduled for display and display a portion of the supplementary media content received with a program or on a program channel.

In some embodiments, outside provider processor 113 may receive media content from media asset server 114 in the form of a program. The program may include several program segments (e.g., non-premium media content such as acts associated with subsequent advertisements) and one or more supplementary program segments.

In an example, outside provider processor 113 may determine that an advertisement suppression feature is enabled (e.g., by accessing databases 112) and provide the program to user equipment 108. As a result, the program segments and supplementary program segment may be displayed on user equipment 108 and advertisements may not be displayed.

In another example, outside provider processor 113 may determine that an advertisement suppression feature is disabled (e.g., by accessing databases 112 or by the lack of user advertisement suppression information) and provide the program segments to user equipment 108 multiplexed with advertisements, or direct user equipment 108 to display advertisements by tuning to an advertisements channel at the end of each program segment. As a result, the program segments and advertisements may be displayed on user equipment 108 and the supplementary program segment may not be displayed. For example, in response to a determination by outside provider processor 113 that an advertisement suppression subscription is disabled, user equipment 108 automatically tunes to the advertisements channel at the end of each of the program segments (e.g., at the commercial breaks). User equipment 108 records the content of the program channel while tuned to the advertisement channel and, once the displayed advertisement is complete, plays the program content from the recording. In some embodiments, the process of playing from the program channel, playing from the recorded program content, and playing from the advertisements channel would continue until the end of the programming block. In certain embodiments, these steps may be performed by service provider 102 and a single data stream may be provided to user equipment 108 on a single channel in accordance with the user advertisement suppression information.

In some embodiments, outside provider processor 113, application 105, or both may implement an interactive gaming environment, or any other suitable hardware or software, on user equipment 108. The interactive gaming environment is associated with an advertisement received from service provider 102 or advertisement server 122 and provides the user with an opportunity to modify an advertisement displayed on user equipment 108, future advertisements, or both. For example, the interactive gaming environment may allow a user to skip through displayed advertisements more quickly when a program is in progress. In some embodiments, the interactive gaming environment may also allow the user to play games with advertisements in order to win advertisement modification credits for modifying the advertisements from that sponsor at a later point in time.

In some embodiments, outside provider processor 113 may receive, from user equipment 108, a user action relating to game play in the interactive gaming environment. Outside provider processor 113 may transmit the received user action to user action server 116. In some embodiments, user action server 116 may cross-reference a received user action with known or expected actions to associate an advertisement modification credit with the user profile of the particular user who provided the action. For example, user action server 116 may receive from user equipment 108, as the user action, an answer to a question provided during game play of the interactive gaming environment. User action server 116 may compare the received answer with a correct answer to determine whether the received answer is correct. User action server 116 may associate an advertisement modification credit with the user profile of the user who provided the action when the answer is correct or alternatively, may not associate an advertisement modification credit with the user profile when the answer is incorrect. For example, user action server 116 may associate a positive value credit (e.g., +1 credit) with the user profile or add an advertisement modification credit to the number of user advertisement modification credits stored in user action server 116 when the answer is correct. In certain embodiments, user action server 116 may associate a negative value credit (e.g., −1 credit) with the user profile or subtract an advertisement modification credit from the amount of user advertisement modification credits in the user profile when the answer is incorrect. In some embodiments, users can use the accumulated credits to purchase products and/or supplemental content. For example, a user can purchase a jacket associated with an advertiser when the user has accumulated the requisite credits. As another example, the user can purchase a mobile phone application associated with the advertiser using the accumulated credits.

In some embodiments, outside provider processor 113 may receive a request from a user to modify an advertisement displayed on user equipment 108. For example, user equipment 108 may transmit information indicative of an action performed by the user in an interactive gaming environment associated with a displayed advertisement displayed on user equipment 108. Outside provider processor 113 may determine whether the requesting user has successfully completed game play in an interactive gaming environment or has acquired a predetermined number of advertisement modification credits before allowing the user to modify the advertisement. For example, outside provider processor 113 may compare the number of advertisement modification credits associated with the user or user equipment 108 to an advertisement modification credit threshold value. In particular, outside provider processor 113 may retrieve from user action server 116 (either randomly or on a last recently stored basis) the number of user advertisement modification credits or the number of creditable user actions, for which a comparison to a predetermined advertisement modification credit threshold may be made. If the comparison is favorable (e.g., the user has performed 3 creditable actions and the advertisement modification credit threshold is 3 credits), outside provider processor 113 may modify the advertisement currently displayed on user equipment 108. For example, outside provider processor 113 may direct application 105 to fast forward through the remainder of the advertisement displayed on user equipment 108 and display the next program segment in the program the user is currently watching. If the comparison is not favorable (e.g., the user has performed 2 creditable actions and the advertisement modification credit threshold is 3 credits), outside provider processor 113 may continue to display the advertisement on user equipment 108.

In some embodiments, outside provider processor 113 may host a website associated with the interactive gaming environment. User equipment 108 may access the website to allow the user to submit user actions, access the interactive gaming environment, or both. Any functionality of the applications provided by user equipment 108 described herein may be provided in a similar manner by accessing a website online using a web browser or other website accessing application running on user equipment 108.

Media asset server 114 may include any suitable computer server equipment capable of broadcasting, storing or delivering media assets (e.g., media content, videos, images, audio, programs, program segments, supplementary media content, supplementary program segments). Media asset server 114 may include traditional head-ends, such as television broadcast stations, and may include Internet servers configured to deliver content upon request (e.g., on-demand, streaming content, downloadable content). In some embodiments, media asset server 114 may send inventory and other information to outside provider processor 113 via communications network 130. For example, media asset server 114 may transmit information regarding media content available via video-on-demand or digital download to outside provider processor 113. The inventory information may be provided, for example, to a media guidance application on user equipment 108. The inventory may include information identifying all or some of the media assets available on media asset server that are provided by users or users of the interactive video gaming application (e.g., using user equipment 108).

Media asset server 114 may store multiple copies of a particular media asset or media asset where each media asset or media asset copy is associated with a different measure of quality. For example, media asset server 114 may store multiple copies of a media asset where the measure of quality of each copy includes different image qualities, aspect ratios, and picture resolutions. Media asset server 114 may associate a class (or set) of videos with a first measure of quality and may associate another class (or set) of videos with a different second measure of quality. The measure of quality of the first class (or set) may be greater than the second class (or set) in that the first class or set may be videos that are longer, more popular among a community, have better content quality, are more original, are better quality, have a greater aspect ratio, have a greater picture resolution or are more rare.

User action server 116 may include any suitable computer server equipment capable of storing or receiving a user action provided by a user of user equipment 108. In some embodiments, user action server 116 may receive from user equipment 108 an action provided by a user during game play in the interactive gaming environment. User action server 116 may receive as the action a response to an inquiry or question provided during the game play. For example, user equipment 108 may receive from a user an action or response indicative of recognition of an advertisement displayed on user equipment 108 and may transmit the action to user action server 116. User action server 116 may transmit user advertisement modification information to outside provider processor 113 to allow user of user equipment 108 in the interactive gaming environment to modify the advertisement displayed on user equipment 108, display supplemental media content on user equipment 108, or both. User action server 116 may communicate with databases 112 to retrieve user profile information and other relevant data for receipt and storage of a user action. In addition, user action server 116 may communicate with databases 112 to store and associate an advertisement modification credit with the received user action. User action server 116 may compute compiled user advertisement modification credit information by adding the advertisement modification credit to the previous number of advertisement modification credits associated with the user. User action server 116 may be queried through outside provider processor 113 or directly by user equipment 108 to retrieve and provide the user with the compiled advertisement modification credit information. Alternatively, user credit information may be provided to user action server 116 from outside provider processor 113 or application 105.

Advertisement server 122 may include any suitable computer server equipment capable of storing, selecting, and transmitting advertisements (e.g., image, video or audio content). In certain embodiments, advertisement server 122 is capable of storing, selecting, and transmitting advertisements that are associated with an interactive gaming environment. In some embodiments, advertisement server 122 may be capable of associating advertisements with media assets stored in media asset server 112. In some embodiments, advertisement server 122 may be capable of multiplexing the advertisements for multiple media assets. For example, advertisement server 122 may multiplex advertisements for programs on two separate channels in order to generate a single advertisement channel for the two program channels.

In some embodiments, advertisement server 122 may be capable of selecting an advertisement that is of a particular length, has particular content or is otherwise related or unrelated to a user action or media asset that is selected or scheduled for delivery to a user. Advertisement server 122 may store in databases 112 an association between different interactive gaming environments and advertisements. Advertisement server 122 may select or suppress an advertisement based on the association, user credit information, and/or advertisement suppression information in databases 112.

In some embodiments, the advertisements stored in advertisement server 122 may be transmitted to user equipment 108 separately from programming (e.g., media assets stored in media asset server 114). For example, an advertiser may sponsor multiple media assets using a specified number of advertisements. In an example, an advertisement associated with a television program broadcast from 9:00 pm to 10:00 pm may also be associated with a different television program transmitted earlier during the same day from 7:00 am to 7:30 am. During the transmission of the earlier television program, the advertisement may have been recorded on user equipment 108, and would not need to be re-transmitted for the later media asset because the advertisement could be played from the recording. As a result, the linking of the advertisements to media assets would only occur as each media asset plays. For example, the particular advertisement that is played on user equipment 108 would be based on sponsoring data transmitted from advertisement server 122 along with each media asset transmitted from media asset server 114. This advertisement delivery process would conserve overall bandwidth in the advertisement management system because each advertisement would not be transmitted in the broadcast data stream every time the advertisement is scheduled for display.

Media processing server 118 may include any suitable computer server equipment capable of processing user actions, media assets and advertisements provided respectively from user action server 116, media asset server 114, and advertisement server 122. Processing may include combining media assets with advertisements stored in advertisement server 122. For example, media processing server 118 may be instructed by outside provider processor 113 to place an advertisement before or at some specified time during playback of the content of media asset so that when the media asset is transmitted for playback to the user, the advertisement is displayed before or at some point during the media asset. Similarly, media processing server 118 may be instructed by outside provider processor 113 to place the advertisement (e.g., video, audio or image) within the content of a media asset so that when the user action or media asset is transmitted for playback to the user, the advertisement is displayed simultaneously with the media asset (e.g., in an opaque, transparent, or partially transparent overlay). Media processing server 118 may also transcode or convert media assets received from one user using one type of media equipment device (e.g., a set-top box) to a form suitable for playback on a different type of media equipment device (e.g., an iPad, a tablet device, or touch screen interface device).

Media processing server 118 may provide the processed user actions, media assets and advertisements to application 105 on user equipment 108 (e.g., through outside provider processor 113 or service provider 102). It should be understood that, in some embodiments, media processing server 118 may be the same server as server 114, 122 and/or 116. Media processing server 118 may also communicate with other servers 120, which may perform some or all of the processing steps.

Other servers 120 may include any suitable computer server equipment not mentioned in the description above. For example, other servers 120 may include image or video processing web sites or applications. In some embodiments, other servers 120 may transmit information to outside provider processor 113 or to application 105 (on user equipment 108) via network 130.

FIG. 2 illustrates an example of generalized user equipment 200 that may be used to implement application 105 and/or all or a portion of the interactive video gaming environment in accordance with some embodiments of the present disclosure. User equipment 200 may be substantially a representation of, or may be implemented within, user equipment devices 104 and 106 of FIG. 1, or user equipment 108, and may thus run application 105. User equipment device 200 may receive and send information from service provider 102 and/or outside provider processor 113 (FIG. 1) via input/output (hereinafter “I/O”) path 202. I/O path 202 may provide data to control circuitry 204, which may include processing circuitry 206, camera 204, and storage 208. I/O path 202 may connect control circuitry 204 (and specifically processing circuitry 206) to communications network 130 of FIG. 1. I/O functions may be provided by one or more communication paths, but are shown as a single path in FIG. 2 to avoid overcomplicating the drawing.

Control circuitry 204 may include any suitable processing circuitry 206 such as processing circuitry based on one or more microprocessors, microcontrollers, digital signal processors, programmable logic devices, etc. In some embodiments, control circuitry 204 executes instructions for application 105 and/or other applications stored in memory (i.e., storage 208). In client-server based embodiments, control circuitry 204 may include communications circuitry suitable for communicating with networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (described in more detail in connection with FIG. 1).

Memory (e.g., random-access memory, read-only memory, or any other suitable memory), hard drives, optical drives, flash drives, optical storage device, or any other suitable fixed or removable storage devices (e.g., DVD recorder, CD recorder, video cassette recorder, or other suitable recording device) may be provided as storage 208 that is part of control circuitry 204. Storage 208 may include one or more of the above types of storage devices. For example, user equipment device 200 may include a hard drive for a DVR (sometimes called a personal video recorder, or PVR) and a DVD recorder as a secondary storage device. Storage 208 may be used to store various types of media and data described herein, including settings information, program information, application settings, user preferences or profile information, media assets, user actions, states within the interactive video gaming environment for one or more users, or other data used in operating application 105 and/or user equipment 208. Nonvolatile memory may also be used (e.g., to launch a boot-up routine and other instructions).

Control circuitry 204 may include video generating circuitry and tuning circuitry, such as one or more analog tuners, one or more MPEG-2 decoders or other digital decoding circuitry, high-definition tuners, or any other suitable tuning or video circuits or combinations of such circuits. For example, control circuitry may include a display driver for driving display 212, any number of buffers (e.g., to hold data to be displayed), and/or switching circuitry (e.g., to select which buffer contains the data to be displayed and/or which buffer should be read by the display driver). Encoding circuitry (e.g., for converting over-the-air, analog, or digital signals to MPEG signals for storage) may also be provided. Control circuitry 204 may also include scaler circuitry for upconverting and downconverting media into the preferred output format of the user equipment 200.

In some embodiments, control circuitry 204 may include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive data for application 105. The circuitry described herein, including, for example, the tuning, video generating, encoding, decoding, scaler, switching, display driver, and analog/digital circuitry, may be implemented using software running on one or more general purpose or specialized processors. If storage 208 is provided as a separate device from user equipment device 200, the tuning and encoding circuitry (including multiple tuners) may be associated with storage 208.

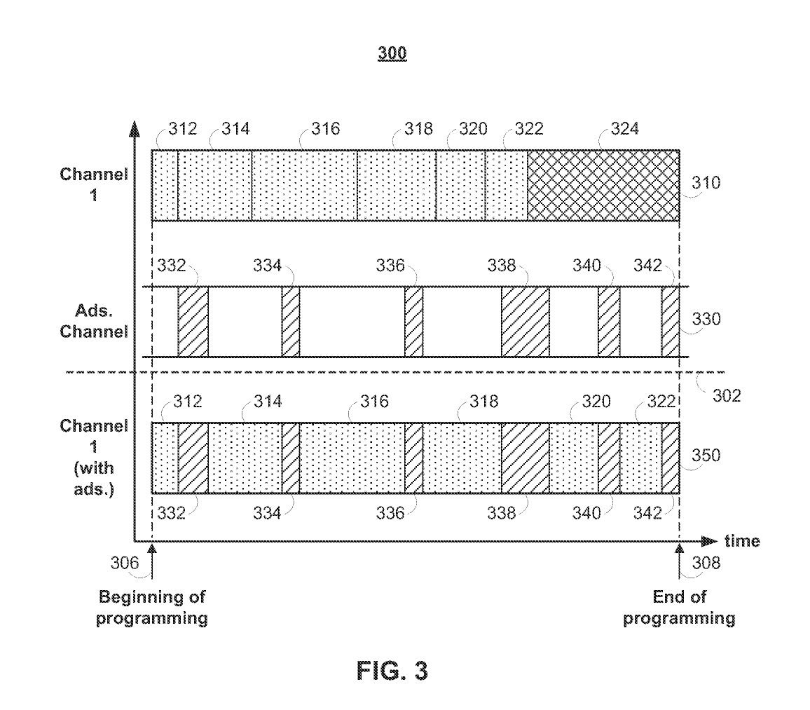

In some embodiments, control circuitry 204 may include multiple tuners to handle simultaneous tuning functions (e.g., watch and record functions, picture-in-picture (PIP) functions, multiple-tuner recording, etc). For example, control circuitry 204 may include one tuner for tuning to a program channel (e.g., media asset data 310 shown in FIG. 3) and another tuner for tuning to an advertisements channel (e.g., advertisements data 330 shown in FIG. 3).

A user may issue commands to the control circuitry 204 using user input interface 210. User input interface 210 may be any suitable user interface, such as a remote control, mouse, trackball, keypad, keyboard, touch screen, touch pad, stylus input, joystick, microphone, voice recognition interface, or other user input interfaces. Display 212 may be provided as a stand-alone device or integrated with other elements of user equipment device 200. Display 212 may be one or more of a monitor, a television, a liquid crystal display (LCD) for a mobile device, light emitting diode (LED) display, plasma display, or any other suitable equipment for displaying visual images. In some implementations, display 212 may be the same device as user input interface 210 (e.g., when user equipment device 200 includes a touch screen interface). Display 212 may include multiple display screens (e.g., one of the front of user equipment device 200 and one of the back of user equipment device 200). In some embodiments, display 212 may be HDTV-capable. Speakers 214 may be provided as integrated with other elements of user equipment device 200 or may be stand-alone units. The audio component of videos and other media content displayed on display 212 may be played through speakers 214. In some embodiments, the audio may be distributed to a receiver (not shown), which processes and outputs the audio via speakers 214.

FIG. 3 illustrates an exemplary data transmission technique 300 for selectively modifying advertisements. Exemplary data transmission technique 300 may also provide supplementary media content to be displayed in place of the skipped advertisements to fill a specified time of programming. The specified time of programming runs from scheduled start time 306 (e.g., “Beginning of programming”) to scheduled end time 308 (e.g., “End of programming”).

The data shown above dashed line 302 is received by the user equipment during the specified time of programming. In particular, media asset data 310 (e.g., “Channel 1”) and advertisements data 330 (e.g., “Advertisements Channel”) may be received by control circuitry 204 (FIG. 2) of user equipment 108 (FIG. 1).

Media asset data 310 includes a plurality of program segments, such as segment 312 (e.g., an opening teaser and credits), segment 314 (e.g., act 1), segment 316 (e.g., act 2), segment 318 (e.g., act 3), segment 320 (e.g., act 4), and segment 322 (e.g., act 5 and closing credits). Advertisements data 330 includes a plurality of advertisements, such as advertisements 332, 334, 336, 338, 340, and 342.

In some embodiments, media asset data 310 includes supplementary media content 324 (e.g., premium media content, extras, or interviews). Supplementary media content 324 may be provided to user equipment 108 (FIG. 1) to fill a specified time of programming created by skipping the advertisements (e.g., from the end of program segment 322 to scheduled end time 308).

In some embodiments, program segments and supplementary media content may be transmitted and received on a first channel. For example, media asset data 310 may be transmitted from service provider 102 (FIG. 1) to user equipment 108 on a first channel (e.g., “Channel 1”). Control circuitry 204 (FIG. 2) may use a tuner to tune to the first channel and receive media asset data 310.

In some embodiments, advertisements may be transmitted and received on a second channel. For example, advertisements data 330 may be transmitted from service provider 102 (FIG. 1) to user equipment 108 on a second channel (e.g., “Advertisements Channel”). Control circuitry 204 (FIG. 2) may use an additional tuner to tune to the second channel and receive advertisements data 330.

In some embodiments, media asset data 310 and advertisements data 330 may be transmitted to and received by user equipment 108 (FIG. 1) using any suitable broadcast standard. Suitable broadcast standards may include National Television System Committee (NTSC), Digital Video Broadcast (DVB), Advanced Television Systems Committee (ATSC), Integrated Services Digital Broadcasting (ISDB), Hybrid Broadcast Broadband TV (HbbTV), Digital Multimedia Broadcast (DMB), Data Over Cable Service Interface Specification (DOCSIS), Digital Audio Broadcasting (DAB), any other suitable standard, and any suitable combination.

In some embodiments, control circuitry 204 (FIG. 2) may bridge broadcast standards and telecom protocols for local area network (LAN), metropolitan area network (MAN), and wide area networks (WAN) connections for use in partially or wholly receiving media asset data 310 and advertisements data 330. For example, control circuitry 204 (FIG. 2) of user equipment 108 (FIG. 1) may include a programmable logic device, such as a field programmable gate array (FPGA), to provide forward error correction and modulation schemes for bridging a digital television broadcast standard and a WAN connection.

In some embodiments, media asset data 310 and advertisements data 330 may be encoded in the ETV Binary Interchange Format (EBIF), received by control circuitry 204 (FIG. 2) as part of a suitable feed, and interpreted by an agent running on processing equipment 202. For example, the application 105 (FIG. 1) may be an EBIF application.

In some embodiments, media asset data 310 and advertisements data 330 may be encoded and transmitted using MPEG-2 or other digital media encoding schemes (e.g., in MPEG-2 object carousels with MPEG audio and video packets of the program segments, supplementary media content, and advertisements).

In some embodiments, media asset data 310, advertisements data 330, or both may include timing information to provide a time reference for identification, editing, and synchronization. Timing information may include time codes indicative of the start of a program segment or advertisement (e.g., start of media), the end of a program segment or advertisement (e.g., end of media), any other suitable information, or any suitable combination. For example, timing information may be a time code transmitted using the Society of Motion Picture and Television Engineers (SMPTE) timecode standard. Time codes may include, for example, linear timecode (LTC), vertical interval timecode (VITC), control track longitudinal (CTL) timecode, burnt-in timecode (BITC), KeyKode, any other suitable technique, or any suitable combination. KEYKODE is a registered trademark owned by Eastman Kodak Company. For example, timing information may be transmitted during the vertical blanking interval (VBI) on each frame of video in media asset data 310 and advertisements data 330 using a vertical interval timecode (VITC) transmission technique.

In some embodiments, outside provider processor 113 (FIG. 1) may access user profile information stored in databases 112 (FIG. 1) and determine whether an advertisement suppression feature associated with the user of user equipment 108 (FIG. 1) is enabled. For example, outside provider processor may determine whether the user is subscribed to an advertisement suppression service. If the user is subscribed to an advertisement suppression service, outside provider processor 113 (FIG. 1) determines that the advertisement suppression status of the user is enabled (e.g., active). If the user is not subscribed to an advertisement suppression service or if the user's subscription has expired, outside provider processor determines that the advertisement suppression status of the user is disabled (e.g., inactive).

If the advertisement suppression status is enabled, outside provider processor 113 (FIG. 1) and application 105 (FIG. 1) may direct control circuitry 204 (FIG. 2) to tune to and display media asset data 310 without tuning to or displaying advertisements data 330. In some embodiments, outside provider processor 113 (FIG. 1) and application 105 (FIG. 1) may direct control circuitry 204 (FIG. 2) to display supplementary media content 324 in place of the skipped advertisements to fill the specified time of programming (e.g., from the end of program segment 322 to end of programming 308). For example, control circuitry 204 (FIG. 2) may tune to the first channel (e.g., media asset data 310 on “Channel 1”) and sequentially display program segments 312, 314, 316, 318, 320, and 322 and supplementary content 324. As a result, the program segments and supplementary media content are displayed on user equipment 108 (FIG. 1) and advertisements are not be displayed.

If an advertisement suppression feature is not enabled (i.e., disabled), the data shown below dashed line 302 is displayed on the user equipment. In particular, display data 350 (e.g., “Channel 1 (with advertisements)”) is a multimedia display signal transmitted from control circuitry 204 (FIG. 2), storage 208 (FIG. 2), or both to display 212 (FIG. 2).

In some embodiments, outside provider processor 113 (FIG. 1) and application 105 (FIG. 1) may direct control circuitry 204 (FIG. 2) to display data 350 by displaying the program segments included in media asset data 310 and the advertisements included in advertisements data 330. For example, control circuitry 204 (FIG. 2) may initially be tuned the first channel (e.g., “Channel 1”) using a first tuner. Control circuitry 204 (FIG. 2) may display program segment 312 on display 212 (FIG. 2). At the end of program segment 312, control circuitry 204 (FIG. 2) may detect timing information, such as an end of media (EOM) time code. If the advertisement suppression status is disabled, control circuitry 204 (FIG. 2) may automatically tune to the advertisements channel using a second tuner and display advertisement 332 on display 212 (FIG. 2). This portion of data transmission technique 300 is illustrated by program segment 312 and advertisement 332 included in display data 350.

In some embodiments, control circuitry 204 (FIG. 2) may begin recording media asset data 310 using the first tuner while displaying advertisement 332 using the second tuner. For example, control circuitry 204 (FIG. 2) may use the first tuner to tune to and record program segments 314, 316, 318, 320, and 322 and supplementary media content 324 in storage 208 (FIG. 2) while the second tuner is tuned to and displaying advertisements received on the advertisements channel (e.g., advertisements data 330).

At the end of advertisement 332, control circuitry 204 (FIG. 2) may detect timing information, such as an end of media (EOM) time code. In response to the detected EOM time code, control circuitry 204 (FIG. 2) may automatically retrieve program segment 314 from storage 208 (FIG. 2) and display program segment 314 on display 212 (FIG. 2). This portion of data transmission technique 300 is illustrated by advertisement 332 and program segment 314 included in display data 350.

This process continues for the duration of the specified time of programming (e.g., until specified end time 308) for a user or user equipment whose advertisement suppression feature is disabled. As a result, program segments and advertisements may be displayed on user equipment 108 (FIG. 1) and supplementary media content may not be displayed. It will be appreciated that the aforementioned features may be included in other advertisement modification techniques of the present disclosure.

In some embodiments, program segments and advertisements may be displayed simultaneously. For example, control circuitry 204 (FIG. 2) may include one tuner for tuning to media asset data 310 and another tuner for tuning to advertisements data 330. Alternatively, advertisements data 330 may be recorded and accessed from storage 208 (FIG. 2). Control circuitry 204 (FIG. 2) may resize and display the advertisements of advertisements data 330 as video, images, or icons without audio in a picture-in-picture (PIP) display window overlaying the video and audio display of display data 350 (e.g., “Channel 1 (with advertisements)”). As a result, program segments and advertisements may be displayed on user equipment 108 (FIG. 1) and supplementary media content (e.g., a portion or all of supplementary media content 324) may also be displayed to fill the specified time of programming.

In some embodiments, unused data bandwidth in the advertisements channel (e.g., the unused transmission space between the end of advertisement 332 and the beginning of advertisement 334) may be reduced by utilizing the advertisements channel to carry additional advertisements for a second channel (e.g., media asset data 310 on “Channel 1”). In some embodiments, the shortest beginning program segment (i.e., teaser) of the two programs may be as long as the shortest first advertising break of the two programs supported by the single advertisements channel in order for the first advertising break on the second program to be composed properly.

In some embodiments, additional advertisements may be included in the advertisements data transmitted to the user equipment (e.g., in addition to the advertisements included in advertisements data 330). The transmission of additional advertisements allows for an increase in bandwidth usage by transmitting data in the unused transmission space between the advertisements for the first program (e.g., from the end of advertisement 332 and the beginning of advertisement 334). For example, unused transmission bandwidth may be reduced by utilizing the advertisements channel to carry additional advertisements for a second channel (e.g., media asset data 310 on “Channel 1”).

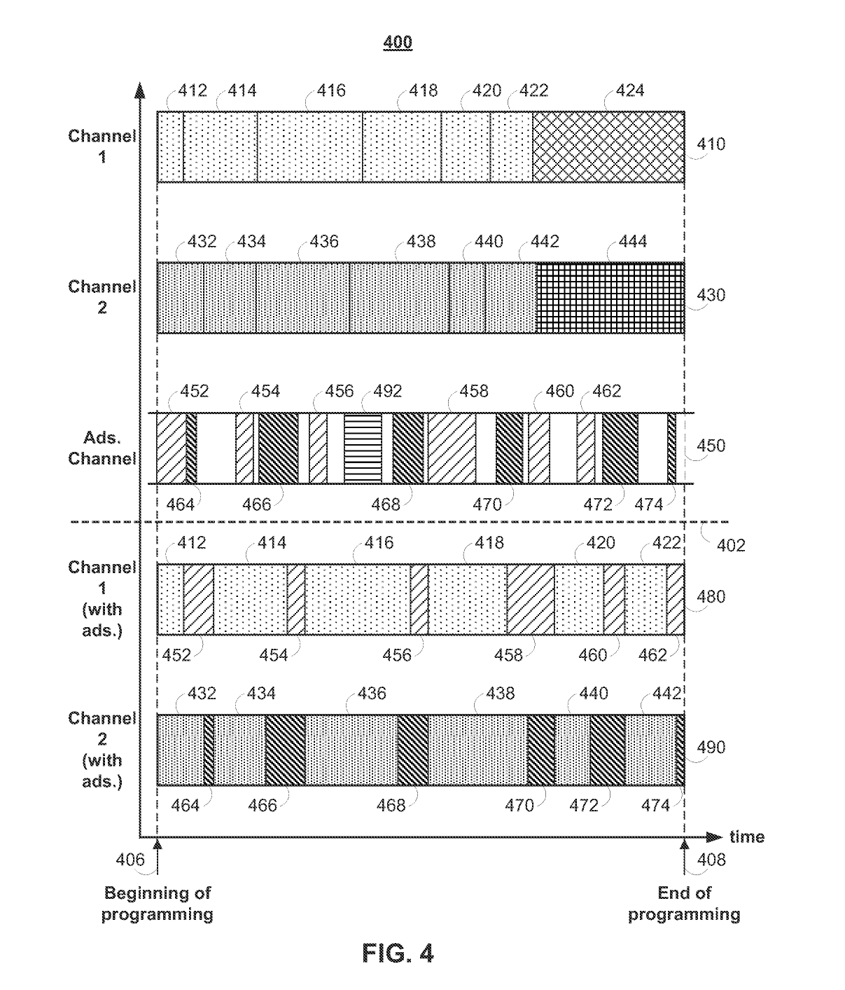

Providing advertisements for multiple programs using a single advertisements channel is described in more detail with reference to FIG. 4 below.

FIG. 4 illustrates another exemplary data transmission technique 400 for selectively modifying advertisements. Exemplary data transmission technique 400 may also provide supplementary media content to be displayed in place of the skipped advertisements to fill a specified time of programming. The specified time of programming runs from scheduled start time 406 (e.g., “Beginning of programming”) to scheduled end time 408 (e.g., “End of programming”). The mechanisms for data transmission, timing, tuning, recording, and displaying data in data transmission technique 500 are similar to the mechanisms discussed with reference to FIG. 3. The mechanisms for determining the status of an advertisement suppression feature associated with the user or the user's equipment are also similar to the mechanisms discussed with reference to FIG. 3.

The data shown above dashed line 402 is received by the user equipment during the specified time of programming. In particular, media asset data 410 (e.g., “Channel 1”) and advertisements data 450 (e.g., “Advertisements Channel”) are received by control circuitry 204 (FIG. 2) of user equipment 108 (FIG. 1). In some embodiments, media asset data 430 (e.g., “Channel 2”) may be received by control circuitry 204 (FIG. 2) in place of, or in addition to, media asset data 410. As illustrated in FIG. 4, the length and timing of the program segments and supplementary media content provided by media asset data 410 and 430 may vary.

Media asset data 410 includes a plurality of program segments, such as segment 412 (e.g., an opening teaser and credits), segment 414 (e.g., act 1), segment 416 (e.g., act 2), segment 418 (e.g., act 3), segment 320 (e.g., act 4), and segment 422 (e.g., act 5 and closing credits). Media asset data 430 includes a plurality of program segments, such as segment 432 (e.g., an opening teaser and credits), segment 434 (e.g., act 1), segment 436 (e.g., act 2), segment 438 (e.g., act 3), segment 440 (e.g., act 4), and segment 442 (e.g., act 5 and closing credits).

In some embodiments, media asset data 410, media asset data 430, or both may include supplementary media content. For example, media asset data 410 and media asset data 430 may include supplementary media content 424 and supplementary media content 444, respectively. Supplementary media content 424 and 444 (e.g., premium media content, extras, or interviews) may be provided to user equipment 108 (FIG. 1) to fill a specified time of programming created by skipping the advertisements (e.g., from the end of program segment 422 to scheduled end time 408, from the end of program segment 442 to scheduled end time 408).

In some embodiments, program segments and supplementary media content may be transmitted and received on a particular channel. For example, media asset data 410 may be transmitted from service provider 102 (FIG. 1) to user equipment 108 on a first channel (e.g., “Channel 1”). Media asset data 430 may be transmitted from service provider 102 (FIG. 1) to user equipment 108 on a second channel (e.g., “Channel 2”). In some embodiments, control circuitry 204 (FIG. 2) may use a tuner to tune to the first channel and receive media asset data 410.

In some embodiments, control circuitry 204 (FIG. 2) may use the same tuner to tune to the second channel and receive media asset data 430 (e.g., if the user changes the channel from “Channel 1” to “Channel 2” using a remote control). In some embodiments, control circuitry 204 (FIG. 2) may use an additional tuner to tune to the second channel and receive media asset data 430 (e.g., if the user has scheduled a recording of “Channel 2” while “Channel 1” is being displayed).

In some embodiments, advertisements may be transmitted and received on a different channel. For example, advertisements data 450 may be transmitted service provider 102 (FIG. 1) to user equipment 108 on a third channel (e.g., “Advertisements Channel”). Control circuitry 204 (FIG. 2) may use an additional tuner to tune to the third channel and receive advertisements data 450.

Advertisements data 450 includes a plurality of advertisements associated with media asset data 410 and media asset data 430 on a single channel to reduce transmission bandwidth. Advertisements associated with media asset data 410 include advertisements 452, 454, 456, 458, 460, and 462. Advertisements associated with media asset data 430 include advertisements 462, 466, 468, 470, 472, and 474.

In some embodiments, the advertisements associated with media asset data 410 and media asset data 430 may be provided as a multiplexed signal on a single channel. For example, service provider 102 (FIG. 1) may multiplex the two sets of advertisements using any suitable multiplexer or multiplexing technique. Suitable multiplexing techniques may include, for example, space-division multiplexing (SDM), time domain statistical multiplexing, frequency-division multiplexing (FDM), time-division multiplexing (TDM), code division multiplexing (CDM), alternate-polarization multiplexing, or any other suitable technique. Control circuitry 204 (FIG. 2) may demultiplex advertisements data 450 using any suitable demultiplexer or demultiplexing technique for use in providing individual advertisements to the user (e.g., to display 212 shown in FIG. 2).

In some embodiments, outside provider processor 113 (FIG. 1) may determine whether an advertisement suppression feature associated with the user of user equipment 108 (FIG. 1) is enabled or disabled.

If the advertisement suppression status is enabled, outside provider processor 113 (FIG. 1) and application 105 (FIG. 1) may direct control circuitry 204

(FIG. 2) to tune to and display media asset data 410 without tuning to or displaying advertisements data 450. In some embodiments, control circuitry 204 (FIG. 2) may display supplementary media content 424 in place of the skipped advertisements to fill the specified time of programming (e.g., from the end of program segment 422 to end of programming 408). For example, control circuitry 204 (FIG. 2) may tune to the first channel (e.g., media asset data 410 on “Channel 1”) and sequentially display program segments 412, 414, 416, 418, 420, and 422 and supplementary content 424. In another example, control circuitry 204 (FIG. 2) may tune to the second channel (e.g., media asset data 430 on “Channel 2”) and sequentially display program segments 432, 434, 436, 438, 440, and 442 and supplementary content 444. As a result, the program segments and supplementary media content are displayed on user equipment 108 (FIG. 1) and advertisements are not be displayed.

If an advertisement suppression feature is not enabled (i.e., disabled), the data shown below dashed line 402 is displayed on the user equipment. In particular, display data 480 (e.g., “Channel 1 (with advertisements)”) is a multimedia display signal transmitted from control circuitry 204 (FIG. 2), storage 208 (FIG. 2), or both to display 212 (FIG. 2). In another example, display data 490 (e.g., “Channel 2 (with advertisements)”) is a multimedia display signal transmitted from control circuitry 204 (FIG. 2), storage 208 (FIG. 2), or both to display 212 (FIG. 2).

In some embodiments, control circuitry may display one or both of display data 480 and display data 490. For example, display data 490 may be displayed in place of display data 480 in response to the user changing the channel from “Channel 1” to “Channel 2” using a remote control (e.g., input device 210 shown in FIG. 2). In another example, the video of display data 490 (e.g., “Channel 2 (with advertisements)” without audio) may be resized and displayed in a picture-in-picture (PIP) display window overlaying the displayed video and audio of display data 480 (e.g., “Channel 1 (with advertisements)”).

In some embodiments, the advertisements in advertisements data 450 may arrive before they are needed. For example, advertisements 452, 454, 456, 458, 460, and 462 may arrive before they are needed in composing the first channel with advertisements (e.g., display data 480). Arranging for advertisements to arrive as early as possible in advertisements data 450 allows for the advertisements channel's bandwidth to be utilized more efficiently than advertisements data 330 (FIG. 3) by decreasing the amount of unused transmission bandwidth (e.g., from the end of advertisement 332 to the beginning of advertisement 334 shown in FIG. 3). As an example, advertisement 462 may arrive before advertisement 472. Because the advertisements arrive before they are needed, the advertisements in advertisements data 450 may be demultiplexed and recorded by control circuitry 204 (FIG. 2) as they arrive. In this embodiment, both the program segments and advertisements shown in displayed data 480 or 490 may be played back from their recordings. Recordings can be made and stored on, for example, storage 208 (FIG. 2).

In some embodiments, the recordings may be made by service provider 102 (FIG. 1) if a session with dedicated bandwidth is established between service provider 102 and the user equipment 108 to deliver the proper video at the proper times. In particular, recording the program segments and the associated advertisements at service provider 102 and then creating an appropriately assembled video experience through an individual connection at user equipment 108 is similar to providing all of the program segments and advertisements as video-on-demand (VOD). Implementing services with and without advertisements via VOD may be accomplished by switching between the recording sources for the program segments and the advertisements.

In some embodiments, data transmission technique 400 may include the transmission of advertisements in advertisements data 450 that are not associated with any program segments, such as loosely-tied advertisement 492. Advertisements that are not associated with any particular scheduled display time and/or channel are referred to herein as loosely-tied advertisements. The transmission of loosely-tied advertisements in advertisements data 450 allows for the advertisements channel's bandwidth to be utilized more efficiently than advertisements data 450 (FIG. 3) by decreasing the amount of unused transmission bandwidth (e.g., from the end of advertisement 456 to the beginning of advertisement 468).

In some embodiments, loosely-tied advertisements may be transmitted and received between advertisements which have time or programming constraints. For example, service provider 102 (FIG. 1) may transmit loosely-tied advertisement 492 to user equipment 108 (FIG. 1) between advertisements 456 and 468.

In some embodiments, loosely-tied advertisement 492 may be an advertisement that may be displayed on user equipment 108 (FIG. 1) at any suitable point. For example, a metadata identifier and specified display criteria may be included in the vertical blanking interval (VBI) of loosely-tied advertisement 492. Control circuitry 204 (FIG. 2) may detect the identifier and determine that advertisement 492 is a loosely-tied advertisement. In an example, control circuitry 204 (FIG. 2) may determine that advertisement 492 may appear between any two program segments in media asset data 410 or media asset data 430. In another example, control circuitry 204 (FIG. 2) may determine that advertisement 492 may appear between any two program segments in any of five channels (e.g., “Channel 12”, “Channel 13”, Channel “24”, Channel 42″, and “Channel 102”, which are not shown in FIG. 4 to avoid overcomplicating the drawing).

In some embodiments, service provider 102 (FIG. 1), control circuitry 204 (FIG. 1), or both may determine the placement of advertisement 492. Control circuitry 204 (FIG. 2) may record loosely-tied advertisement 492 on storage 208 (FIG. 2) for playback whenever a program or channel which meets specified criteria is selected by the user of user equipment 108 (FIG. 1) using user input interface 210 (FIG. 2).

In some embodiments, compression schemes and trickle schemes may be used to transmit the advertisements in advertisements data 450 a faster or slower rate than real-time. For example, a trickle scheme may allow for reduction in bandwidth usage by transmitting the advertisements in advertisements data 450 to user equipment 108 (FIG. 1) in advance over a 24 hour period or any other suitable time period or transmission rate.

In some embodiments, data bandwidth remaining after loosely-tied advertisements (e.g., loosely-tied advertisement 492) are added to advertisements data 450 could be filled with data needed for the interactive video gaming environment, the supplementary media content, interactive television programs, or any other suitable data. In some embodiments, remnant data flow could carry a portion of the cable modem data or telephone traffic assuming service provider 102 (FIG. 1) includes equipment capable of manipulating the remnant data flow for these purposes. It will be appreciated that the aforementioned features may be included in other advertisement suppression techniques of the present disclosure.

In some embodiments, the advertisement management system may provide video for live (e.g., real-time) events, such as sporting events and news programs. To implement advertisement modification features during live programming, the technique for selectively suppressing advertisements is altered to provide the supplementary media content during the time of the advertising breaks for users associated with an enabled advertisement suppression status. For example, a user who has subscribed to an advertisement suppression service would view the supplementary media content instead of the advertisements when watching a live program on user equipment 108 (FIG. 1). The supplementary media content may include, for example, athlete or sport star interviews, historical material related to a news story, or any other suitable programming. Users associated with a disabled advertisement suppression status would see the advertisements instead of the supplementary media content.

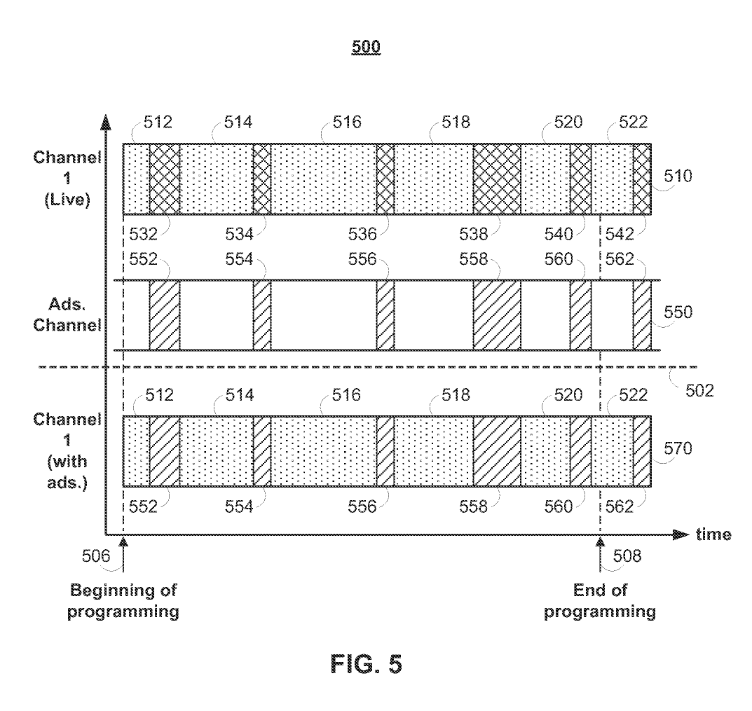

Providing advertisements for a live program is described in more detail with reference to FIG. 5 below.

FIG. 5 illustrates another exemplary data transmission technique 500 for selectively modifying advertisements. Exemplary data transmission technique 500 may also provide supplementary media content (e.g., premium media content, extras, or interviews) to be displayed in place of the skipped advertisements to fill a specified time of programming. The specified time of programming runs from scheduled start time 506 (e.g., “Beginning of programming”) to scheduled end time 508 (e.g., “End of programming”). The mechanisms for data transmission, timing, tuning, recording, and displaying data in data transmission technique 500 are similar to the mechanisms discussed with reference to FIG. 3. The mechanisms for determining the status of an advertisement suppression feature associated with the user or the user's equipment are also similar to the mechanisms discussed with reference to FIG. 3.

The data shown above dashed line 502 is received by the user equipment during the transmission of the live programming. In particular, media asset data 510 (e.g., “Channel 1 (Live)”) and advertisements data 330 (e.g., “Advertisements Channel”) are received by control circuitry 204 (FIG. 2) of user equipment 108 (FIG. 1).

Media asset data 510 includes a plurality of live program segments, such as live program segments 512, 514, 516, 518, 520, and 522. Media asset data 510 includes supplementary media content to fill specified times of programming created by skipping the advertisements (e.g., from the end of live program segment 512 to the beginning of live program segment 514, from the end of live program segment 514 to the beginning of live program segment 516, etc.). Advertisements data 550 includes a plurality of advertisements, such as advertisements 552, 554, 556, 558, 560, and 562.

As shown in FIG. 5, media asset data 510 may extend past the specified time of programming (e.g., program segment 522 and supplementary media content 542 both extend past end of programming 508). For example, media asset data 510 may be a live basketball game scheduled for a three hour time of programming (e.g., 7:00 pm to 10:00 pm). At the end of scheduled game time, the two basketball teams may be tied and the game may enter overtime. The overtime may cause the basketball game to extend past scheduled end time 508 (e.g., the game may end at 10:15 pm, 15 minutes past the scheduled end time).

In some embodiments, each segment of the supplementary media content is the same length as a respective advertisement or group of advertisements to allow for ease of advertisement suppression during live programs. For example, media asset data 310 includes supplementary media content 532, 534, 536, 538, 540, and 542 to fill specified times of programming created by skipping the advertisements 552, 554, 556, 558, 560, and 562, respectively.

In some embodiments, live program segments and supplementary media content may be transmitted and received on a first channel. For example, media asset data 510 may be transmitted from service provider 102 (FIG. 1) to user equipment 108 on a first channel (e.g., “Channel 1 (Live)”). Control circuitry 204 (FIG. 2) may use a tuner to tune to the first channel and receive media asset data 510.

In some embodiments, advertisements may be transmitted and received on a second channel. For example, advertisements data 550 may be transmitted from service provider 102 (FIG. 1) to user equipment 108 on a second channel (e.g., “Advertisements Channel”). Control circuitry 204 (FIG. 2) may use an additional tuner to tune to the second channel and receive advertisements data 550.

In some embodiments, outside provider processor 113 (FIG. 1) may determine whether an advertisement suppression feature associated with the user of user equipment 108 (FIG. 1) is enabled or disabled.

If the advertisement suppression status is enabled, outside provider processor 113 (FIG. 1) and application 105 (FIG. 1) may direct control circuitry 204 (FIG. 2) to tune to and display media asset data 510 without tuning to or displaying advertisements data 550. In particular, control circuitry 204 (FIG. 2) may tune to the first channel (e.g., media asset data 510 on “Channel 1 (Live)”) and sequentially display segments 512, 532, 514, 534, 516, 536, 518, 538, 520, 540, 522, and 542. As a result, the live program segments and supplementary media content are displayed on user equipment 108 (FIG. 1) and advertisements are not be displayed.

If an advertisement suppression feature is not enabled (i.e., disabled), the data shown below dashed line 502 is displayed on the user equipment. In particular, display data 570 (e.g., “Channel 1 (with advertisements)”) is a multimedia display signal transmitted from control circuitry 204 (FIG. 2) to display 212 (FIG. 2).

In some embodiments, outside provider processor 113 (FIG. 1) and application 105 (FIG. 1) may direct control circuitry 204 (FIG. 2) to display data 570 by displaying the live program segments included in media asset data 510 and the advertisements included in advertisements data 550. For example, control circuitry 204 (FIG. 2) may initially be tuned the first channel (e.g., “Channel 1”). Control circuitry 204 (FIG. 2) may display program segment 512 on display 212 (FIG. 2). At the end of program segment 512, control circuitry 204 (FIG. 2) may detect timing information, such as an end of media (EOM) time code. In response to the detected EOM time code associated with program segment 512 (and if the advertisement suppression status is disabled), control circuitry 204 (FIG. 2) may automatically tune to the advertisements channel and display advertisement 552 on display 212 (FIG. 2). At the end of advertisement 552, control circuitry 204 (FIG. 2) may detect timing information, such as an end of media (EOM) time code. In response to the detected EOM time code associated with advertisement 552, control circuitry 204 (FIG. 2) may automatically tune back to the first channel and display advertisement 552 on display 212 (FIG. 2). This portion of data transmission technique 500 is illustrated by program segment 512, advertisement 552, and program segment 514 included in display data 570.

This process continues for the duration of the live programming (e.g., until the end of media asset data 510) for a user or user equipment whose advertisement suppression feature is disabled. As a result, live program segments and advertisements may be displayed on user equipment 108 (FIG. 1) and supplementary media content may not be displayed. It will be appreciated that the aforementioned features may be included in other advertisement modification techniques of the present disclosure.

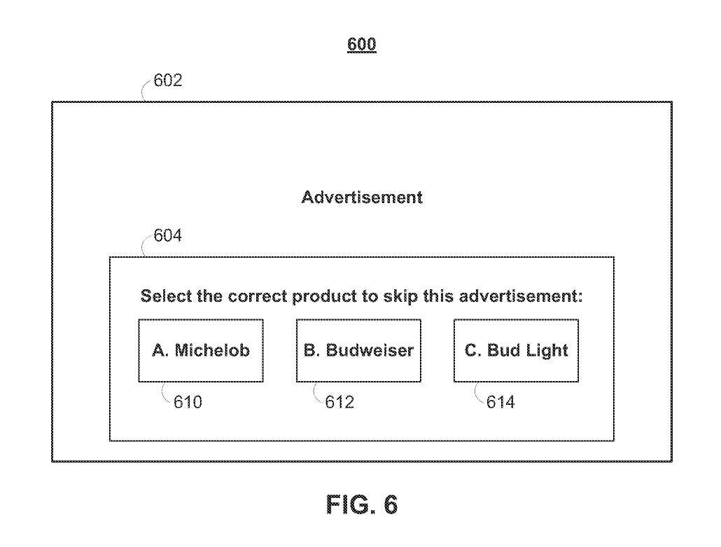

In some embodiments, an advertisement may be selectively modified in response to a user successfully completing game play in an interactive gaming environment associated with the advertisement. Illustrative display screens of the interactive gaming environment used in selectively modifying the display of advertisements are discussed in reference to FIGS. 6-8.

FIG. 6 shows an illustrative interactive gaming environment display screen 600 for providing an interactive gaming environment associated with an advertisement. In some embodiments, the interactive gaming environment may provide access to any suitable type of content in a single display, a single screen overlay over media content being displayed, multiple displays, multiple screen overlays over media content being displayed, any other suitable display, or any suitable combination and may be updated at any suitable time interval.

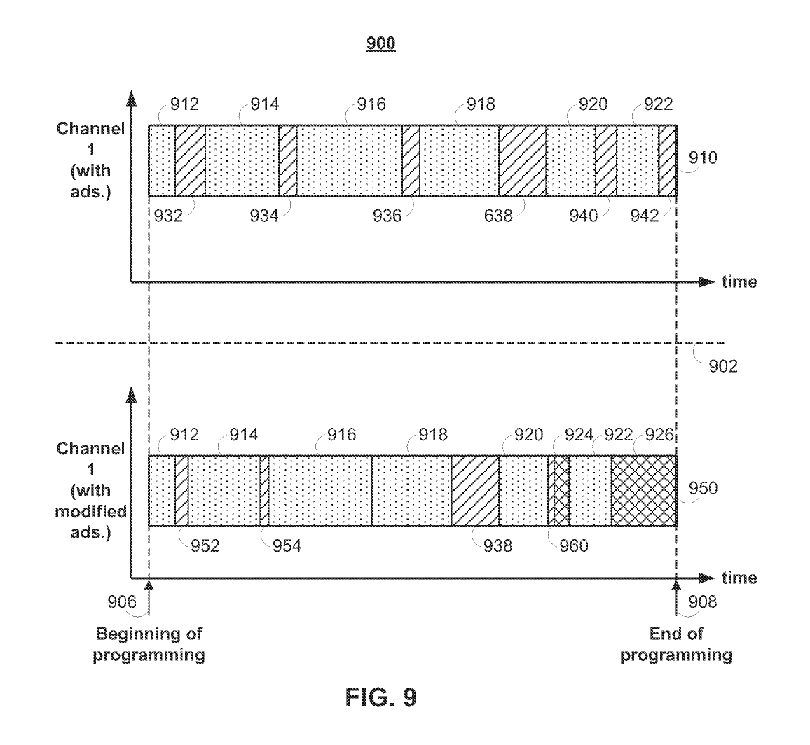

In some embodiments, outside provider processor 113 (FIG. 1) and application 105 provide the interactive gaming environment to user equipment 108 (FIG. 1) in association with an advertisement (e.g., advertisement 932 shown in FIG. 9) transmitted to user equipment 108 from any suitable source (e.g., advertisement server 122 or service provider 102 shown in FIG. 1). The interactive gaming environment is beneficial to advertisers because it may increase their impression on the user by actively involving the user in the display of the advertisement. User equipment 108 (FIG. 1) displays interactive gaming environment display screen 600 on display 212 (FIG. 2).

In some embodiments, the interactive gaming environment is provided in interactive gaming environment display region 604 and is associated with an advertisement displayed in advertisement display region 602. Interactive gaming environment display region 604 may include selectable fields 610, 612, and 614 for providing a user action using, for example, user input interface 210 (FIG. 2).

In some embodiments, the interactive gaming environment may provide a question or prompt (e.g., “Select the correct product to skip this advertisement”) in interactive gaming environment display region 604. For example, the interactive gaming environment may prompt the user to guess what product the advertisement is for. The user of user equipment 108 (FIG. 1) may provide a user action relating to game play in the interactive environment by, for example, selecting one or more of selectable fields 610 (e.g., “A. Michelob”), 612 (e.g., “B. Budweiser”), or 614 (e.g., “C. Bud Light”). For example, user action server 116 (FIG. 1) may receive from user equipment 108, as the user action, selection of field 612 as the answer to the question or prompt provided in interactive gaming environment display region 604. User action server 116 may compare the received answer with a correct answer to determine whether the received answer is correct. For example, the correct answer may be a data entry (e.g., “B. Budweiser”) stored in user action server 116. User action server 116 may award an advertisement modification credit to the user when the answer is correct or alternatively, may not associate an advertisement modification credit with the user profile when the answer is incorrect. In an example, selectable field 612 (e.g., “B. Budweiser”) may be the creditable user action (e.g., the advertisement displayed in advertisement display region 602 may be a video advertisement for Budweiser brand beer sponsored by Anheuser-Busch). In response to the selection of selectable field 612, user action server 116 (FIG. 1) will determine that the user action is creditable. In response to the determination, outside provider processor 113 (FIG. 1) may modify the advertisement displayed in advertisement display region 602, user action server 116 (FIG. 1) may associate an advertisement modification credit with the user profile in association with the sponsor of the advertisement (e.g., Anheuser-Busch), or both in accordance with some embodiments of the present disclosure.

Display screen 600 may include one or more display regions, one or more advertisements, one or more options regions, any other suitable region, or any suitable combination. In some embodiments, display screen 600 may be personalized in accordance with some embodiments of the present disclosure. It will be appreciated that the aforementioned features may be included in other display screens of the present disclosure.

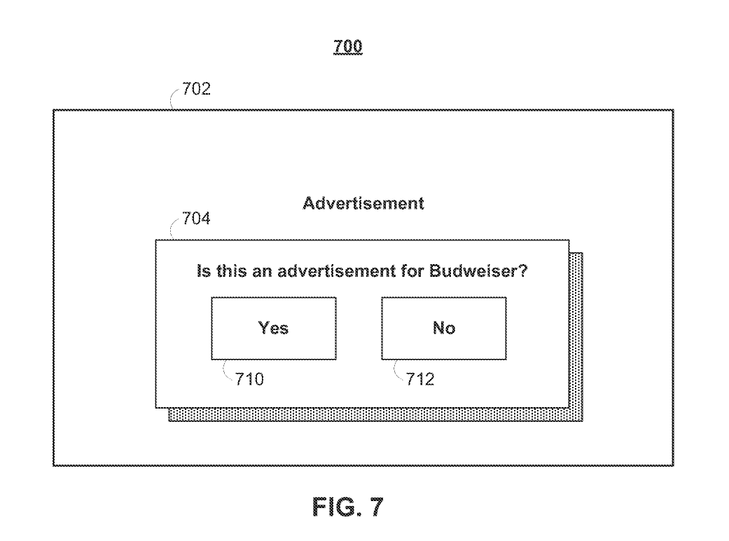

FIG. 7 shows another illustrative interactive gaming environment display screen 700 for providing an interactive gaming environment associated with an advertisement. It will be appreciated that the features described with reference to display screen 700 may be included in other display screens of the present disclosure.

In some embodiments, outside provider processor 113 (FIG. 1) and application 105 provide the interactive gaming environment to user equipment 108 (FIG. 1) in association with an advertisement (e.g., advertisement 934 shown in FIG. 9) transmitted to user equipment 108 from any suitable source (e.g., advertisement server 122 or service provider 102 shown in FIG. 1). User equipment 108 (FIG. 1) displays interactive gaming environment display screen 700 on display 212 (FIG. 2).

In some embodiments, the interactive gaming environment is provided in interactive gaming environment display region 704 and is associated with an advertisement displayed in advertisement display region 702. For example, interactive gaming environment display region 704 may be a foreground overlay display region displayed over advertisement display region 702 and may include selectable fields 710 and 712 for providing a user action using, for example, user input interface 210 (FIG. 2).

In some embodiments, the interactive gaming environment may provide a question or prompt (e.g., “Is this an advertisement for Budweiser?”) in interactive gaming environment display region 704. For example, the interactive gaming environment may prompt the user to select the specific product featured in the advertisement from a binary list, such as a true-or-false statement or yes-or-no question. The user of user equipment 108 (FIG. 1) may provide a user action relating to game play in the interactive environment by, for example, selecting selectable field 710 (e.g., “Yes”) or selectable field 712 (e.g., “No”). For example, user action server 116 (FIG. 1) may receive from user equipment 108, as the user action, selection of field 710 as the answer to the question or prompt provided in interactive gaming environment display region 704. User action server 116 (FIG. 1) may compare the received answer with a correct answer to determine whether the received answer is creditable. User action server 116 (FIG. 1) may associate an advertisement modification credit with the user profile when the answer is correct or alternatively, may not associate an advertisement modification credit with the user profile when the answer is incorrect. In an example, selectable field 710 (e.g., “Yes”) may be the creditable user action (e.g., the advertisement displayed in advertisement display region 702 may be a video advertisement for Budweiser brand beer sponsored by Anheuser-Busch). In response to the selection of selectable field 710, user action server 116 (FIG. 1) may determine that the user action is creditable. In response to the determination, outside provider processor 113 (FIG. 1) may modify the advertisement displayed in advertisement display region 702, user action server 116 (FIG. 1) may associate an advertisement modification credit with the user profile in association with the sponsor of the advertisement (e.g., Anheuser-Busch), or both in accordance with some embodiments of the present disclosure.

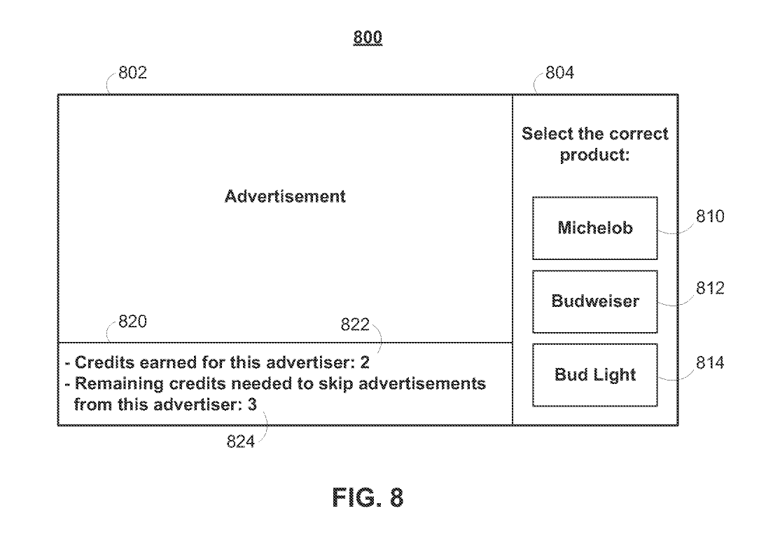

FIG. 8 shows another illustrative interactive gaming environment display screen 800 for providing an interactive gaming environment associated with an advertisement. It will be appreciated that the features described with reference to display screen 800 may be included in other display screens of the present disclosure.

In some embodiments, outside provider processor 113 (FIG. 1) and application 105 provide the interactive gaming environment to user equipment 108 (FIG. 1) in association with an advertisement (e.g., advertisement 938 shown in FIG. 9) transmitted to user equipment 108 from any suitable source (e.g., advertisement server 122 or service provider 102 shown in FIG. 1). User equipment 108 (FIG. 1) displays interactive gaming environment display screen 800 on display 212 (FIG. 2).

In some embodiments, the interactive gaming environment is provided in interactive gaming environment display region 804 and is associated with an advertisement displayed in advertisement display region 802. In some embodiments, the advertisement displayed in display region 802 may be resized, reformatted, or both to accommodate display regions 804 and 820.

In some embodiments, user advertisement modification credit information (e.g., information stored in user action server 116, databases 112, or advertisement server 122 shown in FIG. 1) may be displayed in display region 820. In some embodiments, display region 820 may include field 822 (e.g., “Credits earned for this advertiser) for displaying the number of user advertisement modification credits associated with the sponsor of the advertisement displayed in display region 802. In some embodiments, display region 820 may include field 824 (e.g., “Remaining credits needed to skip advertisements from this advertiser: 3”) for displaying the advertisement modification credit threshold or a comparison of the user advertisement modification credits and the advertisement modification threshold. For example, the information displayed in display region 820 may be indicative of two user advertisement modification credits associated with the sponsor of the advertisement displayed in display region 802, an advertisement modification credit threshold of five credits, and a comparison of credits needed to modify an advertisement of three credits (e.g., the difference between the five credit threshold and the two user credits).

In some embodiments, interactive gaming environment display region 804 may include selectable fields 810, 812, and 814 for providing a user action using, for example, user input interface 210 (FIG. 2). For example, the interactive gaming environment may provide a question or prompt (e.g., “Select the correct product:”) in interactive gaming environment display region 804. For example, the interactive gaming environment may prompt the user to select the specific product featured in advertisement display region 802 from a multiple choice list. The user of user equipment 108 (FIG. 1) may provide a user action relating to game play in the interactive environment by, for example, selecting one or more of selectable fields 810 (e.g., “Michelob”), 812 (e.g., “Budweiser”), and 814 (e.g., “Bud Light”). For example, user action server 116 (FIG. 1) may receive from user equipment 108, as the user action, selection of field 812 as the answer to the question or prompt provided in interactive gaming environment display region 804.

In some embodiments, user action server 116 (FIG. 1) may compare the received answer with a correct answer to determine whether the received answer is creditable. User action server 116 (FIG. 1) may associate an advertisement modification credit with the user profile when the answer is correct or alternatively, may not associate an advertisement modification credit with the user profile when the answer is incorrect.

In an example, selectable fields 812 (e.g., “Budweiser”) and 814 (e.g., “Bud Light”) may each be a correct answer (e.g., the advertisement displayed in advertisement display region 802 may be a video advertisement for Budweiser and Bud Light brand beers sponsored by Anheuser-Busch). In response to the selection of selectable field 812, 814, or both, user action server 116 (FIG. 1) may determine that the user action is creditable. In response to the determination, outside provider processor 113 (FIG. 1) may modify the advertisement displayed in advertisement display region 802, user action server 116 (FIG. 1) may associate an advertisement modification credit with the user profile in association with the sponsor of the advertisement (e.g., Anheuser-Busch), or both in accordance with some embodiments of the present disclosure. For example, user action server may update the number of user advertisement modification credits to three credits in response to selection of field 812.

While FIGS. 6-8 depict game play in multiple choice interactive gaming environments, the interactive game may be any suitable game (e.g., racing, shooting, dancing, etc.). In some embodiments, the interactive gaming environment may also be capable of recognizing voice and/or user motions as user actions relating to game play in the interactive gaming environment.

FIG. 9 illustrates an exemplary data transmission technique 900 for selectively modifying the display of an advertisement based on an interactive video gaming environment associated with the advertisement. The mechanisms for data transmission, timing, tuning, recording, and displaying data in data transmission technique 900 are similar to the mechanisms discussed with reference to FIG. 3.

The data shown above dashed line 902 represents unmodified display data (e.g., data that is displayed before, or without, being modified in response to a user action in the interactive gaming environment). In some embodiments, control circuitry 204 (FIG. 2) of user equipment 108 (FIG. 1) may transmit unmodified display data 910 (e.g., “Channel 1 (with advertisements)”) to display 212 (FIG. 2). Display data 910 includes program segments 912, 914, 916, 918, 920, and 922 and advertisements 932, 934, 936, 938, 940, and 942. Unmodified display data 910 may be similar to display data 350, 480, 490, or 570 described with reference to FIGS. 3-5.

In some embodiments, one or more program segments and advertisements may be recorded ahead of time (e.g., in storage 208 shown in FIG. 2). Control circuitry 204 (FIG. 2) may skip an advertisement or a group of advertisements in response to the user successfully completing game play in the interactive gaming environment using user input interface 210 (FIG. 2).

The data shown below dashed line 902 represents modified display data (e.g., data that is displayed after modified in response to a user action in the interactive gaming environment) for various advertisement modification scenarios. During the display of an advertisement (e.g., advertisement 932), outside provider processor 113 (FIG. 1) and application 105 (FIG. 1) may initiate an interactive gaming environment associated with the displayed advertisement. In some embodiments, the interactive gaming environment may be transmitted to and received by user equipment 108 (FIG. 1) on one or more analog or digital television channels, on a television channel sideband, in the vertical blanking interval of a television channel, using an in-band digital signal, using an out-of-band digital signal, in a continuous feed, in a trickle feed, or by any other suitable data transmission technique.

In some embodiments, the user may provide a user action relating to game play in an interactive gaming environment associated with advertisement 932. User action server 116 (FIG. 1) may determine that the user action is a correct response and, in response, the remainder of advertisement 932 may be skipped. This process is illustrated by advertisement 952, in which the user has successfully completed game play during the display of advertisement 932 and the remainder of advertisement 932 has been skipped.

In some embodiments, the user may be awarded with a credit for successfully completing the game play in the interactive gaming environment. For example, user action server 116 (FIG. 1) may associate an advertisement modification credit (e.g., +1 credit) with the user profile of the particular user who provided the action relating to game play in the interactive gaming environment associated with advertisement 932.

In some embodiments, the user may provide a user action relating to game play in an interactive gaming environment associated with advertisement 934, which may be different that the interactive gaming environment associated with advertisement 932. User action server 116 (FIG. 1) may determine that the user action is a correct response and, in response, the remainder of advertisement 934 may be skipped. This process is illustrated by advertisement 954, in which the user has successfully completed game play during the display of advertisement 934 and the remainder of advertisement 934 has been skipped. In some embodiments, user action server 116 (FIG. 1) may associate an advertisement modification credit (e.g., +1 credit) with the particular user who provided the action relating to game play in the interactive gaming environment associated with advertisement 934.

In some embodiments, outside provider processor 113 (FIG. 1) may determine whether the user has performed a predetermined number of creditable user actions or has acquired a predetermined number of advertisement modification credits before allowing the modification of future advertisements. In particular, outside provider processor 113 may retrieve from user action server 116 (either randomly or on a last recently stored basis) the number of user advertisement modification credits or the number of creditable user actions. For example, user action server 116 (FIG. 1) may associate an advertisement modification credit with each of the user actions relating to game play in the interactive gaming environments associated with advertisements 932 and 934. User action server 116 (FIG. 1) may update the user advertisement modification credits associated with the advertiser of advertisements 932 and 934 to two credits (e.g., +1 credit for the user action associated with advertisement 932, and +1 credit for the user action associated with advertisement 934).

In some embodiments, outside provider processor 113 (FIG. 1) may compare the number of user advertisement modification credits to an advertisement modification credit threshold value. If the number of advertisement modification credits associated with the user are equal to or greater than the number of advertisement modification credits required to modify the advertisement, user equipment 108 (FIG. 1) may modify the display or delivery of future advertisements provided or scheduled for display during the specified time of programming or any suitable duration. For example, advertisements 936 and 942 may be sponsored by the same advertiser as advertisements 932 and 934 and the advertisement modification credit threshold associated with the advertiser may be two credits. Outside provider processor 113 (FIG. 1) and application 105 may direct control circuitry 204 (FIG. 2) not to display advertisements 936 and 942 because the comparison of the user advertisement modification credits associated with the advertiser (e.g., two credits) is equal to the advertisement modification threshold (e.g., two credits).

In some embodiments, the user may provide a user action relating to game play in an interactive gaming environment associated with advertisement 938. User action server 116 (FIG. 1) may determine that the user action is not creditable (e.g., an incorrect response). In response to the user unsuccessfully completing the game play, the remainder of advertisement 934 may be displayed.

In some embodiments, the user may not be awarded with a credit for unsuccessfully completing the game play in the interactive gaming environment. For example, user action server 116 (FIG. 1) may not associate an advertisement modification credit with the user profile of the particular user who provided the incorrect answer in the interactive gaming environment associated with advertisement 938.

In some embodiments, outside provider processor 113 (FIG. 1) and application 105 (FIG. 1) may initiate an interactive gaming environment associated with advertisement 940 in response to determining that the user has no advertisement modification credits associated with the advertiser of advertisement 940, which may be associated with a different advertiser than the advertiser which sponsors advertisements 932, 934, 936, and 942. The user may provide a user action relating to game play in an interactive gaming environment associated with advertisement 940. User action server 116 (FIG. 1) may determine that the user action is creditable (e.g., a correct response) and, in response, the remainder of advertisement 940 may be skipped and supplementary media content may be provided to fill the remainder of the advertising break associated with advertisement 940. This process is illustrated by advertisement 960, which is a modified version of advertisement 940, and supplementary media content 924. In some embodiments, user action server 116 (FIG. 1) may associate an advertisement modification credit (e.g., +1 credit) with the user profile of the particular user who provided the action relating to game play in the interactive gaming environment associated with advertisement 940.

In some embodiments, display data 910 may be a live program and supplementary media content 924 may be similar to supplementary media content 540 described with reference to FIG. 5. In this embodiment, the user playing the interactive game associated with advertisement 940 would miss the beginning of the supplementary content during the time that advertisement 960 is displayed (e.g., before the remainder of advertisement 960 is skipped). This may provide the user with further incentive to subscribe to the advertisement suppression service of the present disclosure or to play games associated with advertisements before the live broadcast in order to view all of the supplementary content during the live broadcast.

In some embodiments, the user may play interactive games to increase the user's advertisement modification credits for use in modifying future advertisements. For example, if a number of advertisements are available on storage 208 (FIG. 2), then the advertisements may be played from the recordings and interactive gaming environments may be initiated. The user may play any number of interactive gaming environments to increase the user's total number of advertisement modification credits. For example, outside provider processor 113 (FIG. 1) may allow the user to watch the prerecorded advertisements and identify the associated products to build advertisement modification credits for skipping through advertisements when watching future programs (e.g., a program scheduled to be displayed the following day). Since the user is playing a game which directly benefits the sponsor by advertising the sponsor's product, the sponsor, the service provider, or both may reward the user with advertisement-free or advertisement-reduced programs at a later point in time.

In some embodiments, the interactive gaming environment may itself be the advertisement. For example, the interactive gaming environment may provide trivia games about an advertiser's products, shooting games at icons associated with an advertiser's products, driving games through virtual speedways plastered with advertising posters and billboards, or any other suitable game for which the user may be awarded with advertisement modification credits to modify the display of advertisements at a later time. It will be appreciated that the aforementioned features may be included in other advertisement suppression techniques of the present disclosure.

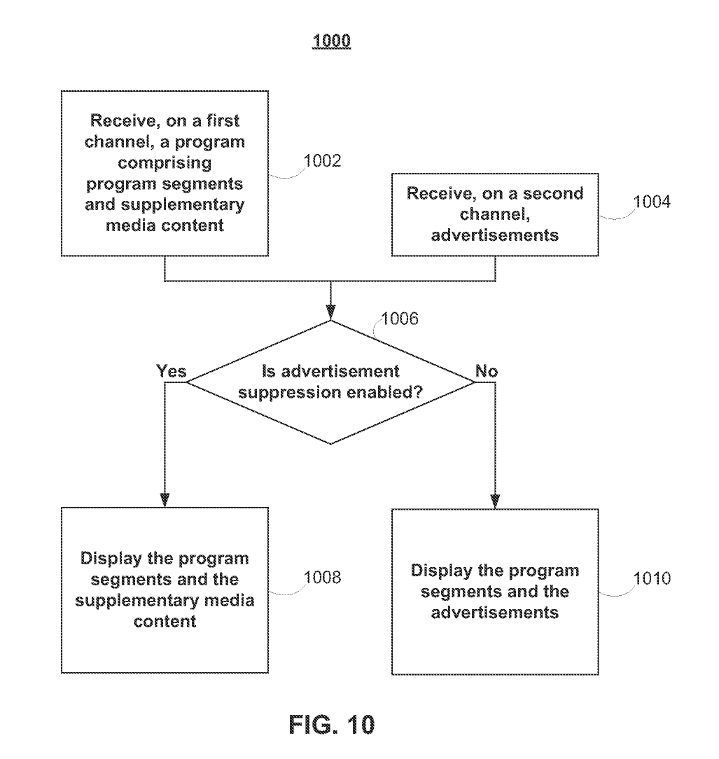

FIG. 10 is a flow chart of illustrative steps involved in selectively suppressing advertisements and providing supplementary media content in accordance with some embodiments of the present disclosure.

At step 1002, a program comprising program segments and supplementary media content (e.g., premium media content, extras, or interviews) is received on a first channel. For example, user equipment 108 (FIG. 1) may receive media asset data 310 (FIG. 3), 410 (FIG. 4), 430 (FIG. 4), or 510 (FIG. 5) from service provider 102 (FIG. 1) or any other suitable source through communications path 132, 133, or 134 (FIG. 1).

At step 1004, one or more advertisements are received on a second channel. For example, user equipment 108 (FIG. 1) may receive advertisements data 330 (FIG. 3), 450 (FIG. 4), or 550 (FIG. 5) service provider 102 (FIG. 1), or any other suitable source through communications path 132, 133, or 134 (FIG. 1).

At step 1006, a determination is made regarding whether advertisement suppression is enabled. For example, outside provider processor 113 (FIG. 1) may query user profile information stored in databases 112 (FIG. 1) to determine the status of an advertisement suppression subscription associated with the user of user equipment 108 (FIG. 1). In some embodiments, outside provider processor 113 (FIG. 1) may determine that the advertisement suppression status is either enabled (e.g., the user is subscribed to an advertisement suppression service) or disabled (e.g., the user is not subscribed to an advertisement suppression service or the user's subscription has expired). If advertisement suppression is enabled, the process may proceed to step 1008. If advertisement suppression is not enabled, the process may proceed to step 1010.

At step 1008, in response to determining that advertisement suppression is enabled, the received program segments and supplementary media content are displayed. In some embodiments, outside provider processor 113 (FIG. 1) may direct user equipment 108 (FIG. 1) to display programming content without advertisements (e.g., by not tuning to an advertisements channel), display supplementary media content (e.g., in place of advertisements or at the end of the program to fill a specified time of programming), or both. For example, outside provider processor 113 may direct user equipment 108 to display media asset data 310 (FIG. 3), media asset data 410 (FIG. 4), media asset data 430 (FIG. 4), or media asset data 510 (FIG. 5) on display 212 (FIG. 2).

At step 1010, in response to determining that advertisement suppression is disabled, the received program segments and advertisements are displayed. For example, control circuitry 204 (FIG. 2) may display data 350 (FIG. 3) in response to a determination that the advertisement suppression status of the user or of user equipment 108 (FIG. 1) is disabled. In some embodiments, outside provider processor 113 (FIG. 1) may direct user equipment 108 (FIG. 1) to display advertisements by tuning to an advertisements channel at the end of a program segment (e.g., at an advertising break), to not display supplementary media content, or both. In some embodiments, user equipment 108 may automatically tune to the second channel (e.g., the advertisements channel) at the end of each of the program segments (e.g., at the commercial breaks). User equipment 108 may record the content of the first channel (e.g., the program channel) while tuned to the second channel and, once the displayed advertisement is complete, play the program content from the recording. In some embodiments, the process of playing from the first channel, playing from the recorded program content, and playing from the second channel would continue until the end of the programming block. For example, outside provider processor 113 (FIG. 1) may direct user equipment 108 to display data 350 (FIG. 3), data 480 (FIG. 4), data 490 (FIG. 4), or data 570 (FIG. 5) on display 212 (FIG. 2). In certain embodiments, these steps may be performed by service provider 102 and a single data stream may be provided to user equipment 108 on a single channel in accordance with the user advertisement suppression information.

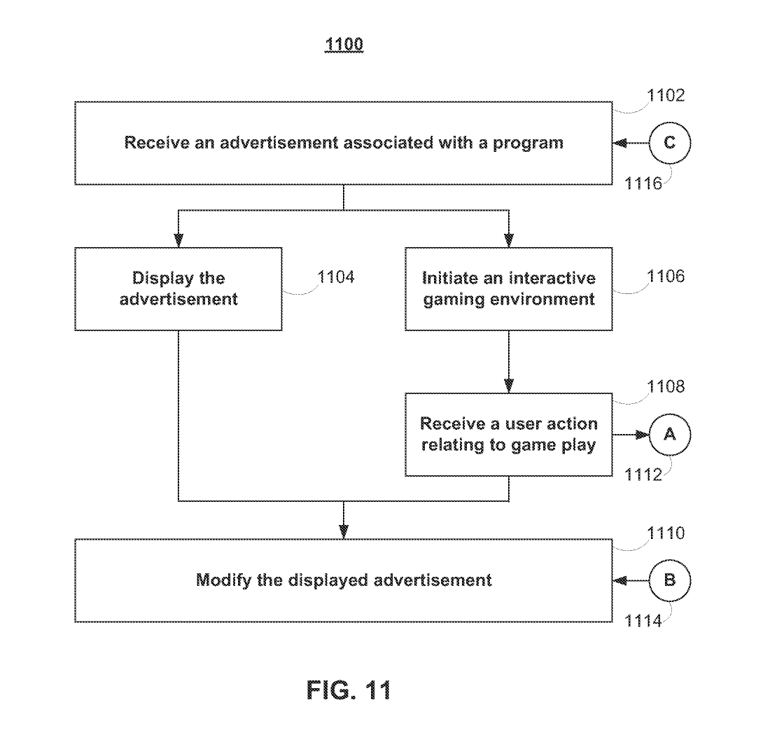

FIG. 11 is a flow chart of illustrative steps involved in selectively modifying the display of advertisements based on game play in accordance with some embodiments of the present disclosure.

At step 1102, an advertisement associated with a program is received. For example, user equipment 108 (FIG. 1) may receive display data 910 (FIG. 9) from media asset server 114 (FIG. 1), advertisement server 122 (FIG. 1), service provider 102 (FIG. 1), or any other suitable source through communications path 132, 133, or 134 (FIG. 1).

At step 1104, the received advertisement is displayed. For example, user equipment 108 (FIG. 1) may display advertisement 932 (FIG. 9) in advertisement display region 602 (FIG. 6), 702 (FIG. 7), or 802 (FIG. 8) using display 212 (FIG. 2).

At step 1106, an interactive gaming environment associated with the advertisement is initiated. For example, outside provider processor 113 (FIG. 1) and application 105 (FIG. 1) may initiate an interactive gaming environment associated with the advertisement displayed at step 1104. In some embodiments, outside provider processor 113 (FIG. 1) and application 105 (FIG. 1) may display the interactive gaming environment in interactive gaming environment display region 604 (FIG. 6), 704 (FIG. 7), or 804 (FIG. 8) using display 212 (FIG. 2).

At step 1108, a user action relating to game play in the interactive gaming environment is received. For example, the user action may be an answer to a question provided during game play of the interactive gaming environment associated with advertisement 932 (FIG. 9) in response to a user selecting field 610 (FIG. 6), 612 (FIG. 6), 614 (FIG. 6), 710 (FIG. 7), 712 (FIG. 7), 810 (FIG. 8), 812 (FIG. 8), or 814 (FIG. 8) using user input interface 210 (FIG. 2).

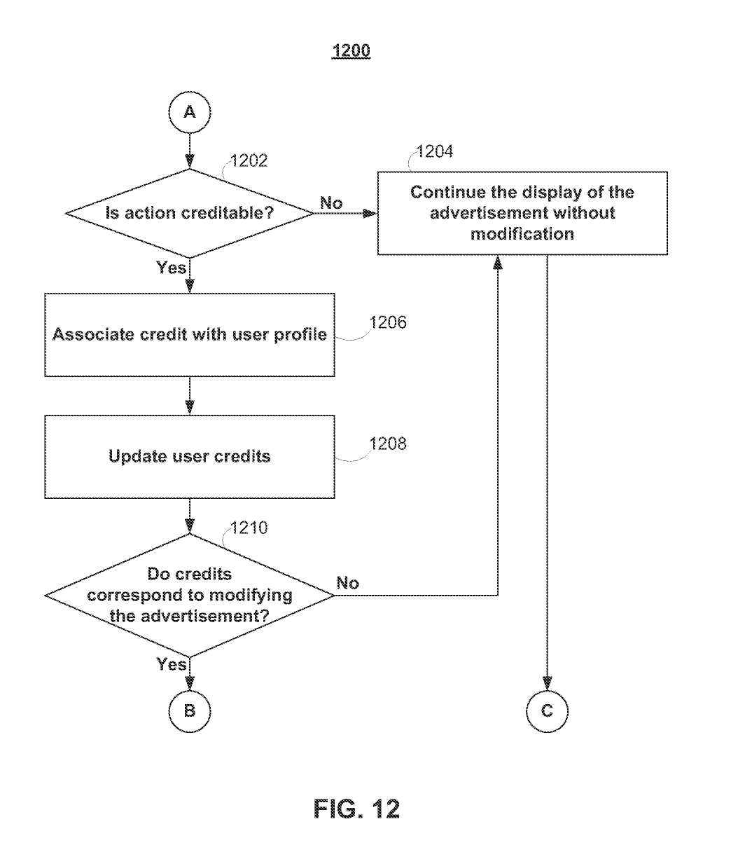

In some embodiments, additional steps may be provided to award a user advertisement modification credit to the user when the user succeeds in the interactive game play. For example, the user may successfully complete game play in the interactive gaming environment when the user selects the correct answer in a question-and-answer game, shoots all of the targets in a shooting game, surpasses the scoring threshold for a racing game, or performs any other suitable action or combination of actions. These additional steps may be performed at step 1112 as described with respect to process 1200 shown in FIG. 12. These additional steps may return to process 1100 at step 1114 if the number of user advertisement modification credits corresponds to modifying the advertisement. These additional steps may return to process 1100 at step 1116 if the number of user advertisement modification credits is less than the number of advertisement modification credits required to modify the advertisement.

At step 1110, the displayed advertisement is modified in accordance with some embodiments of the present disclosure. For example, outside provider processor 113 (FIG. 1) may direct user equipment 108 (FIG. 1) to modify the displayed advertisement by displaying advertisement 952 (FIG. 9), which is a modified version of advertisement 932. In another example, outside provider processor 113 (FIG. 1) may direct user equipment 108 (FIG. 1) to modify the displayed advertisement by displaying supplementary content 924 (FIG. 9) or 926 (FIG. 9).

FIG. 12 is a flow chart of illustrative steps involved in associating advertisement modification credits with user actions for selectively modifying the display of advertisements in accordance with some embodiments of the present disclosure.

At step 1202, a determination is made regarding whether or not the user action received at step 1108 of FIG. 11 is creditable. For example, user action server 116 (FIG. 1) may determine that the user action is creditable (e.g., a correct response) to a question or prompt provided in interactive gaming environment display region 604 (FIG. 6), 704 (FIG. 7), or 804 (FIG. 8). If the user action is creditable (e.g., the user selects field 612 (FIG. 6), 710 (FIG. 7), 812 (FIG. 8), or 814 (FIG. 8) using user input interface 210 shown in FIG. 2), the process may proceed to step 1206. If the user action is not creditable (e.g., the user selects field 610 (FIG. 6), 614 (FIG. 6), 712 (FIG. 7), or 810 (FIG. 8) using user input interface 210 shown in FIG. 2), the process may proceed to step 1204.

At step 1204, the display of the advertisement is continued on user equipment 108 (FIG. 1). For example, the remainder of advertisement 938 (FIG. 9) may be displayed on display 212 (FIG. 2) and an advertisement modification credit may not be associated with the user profile of the user who provided the action. Process 1200 then proceeds to step 1116 shown in FIG. 11 and ends.

At step 1206, an advertisement modification credit is associated with the user profile of the user who provided the action relating to game play in the interactive gaming environment. For example, user action server 116 (FIG. 1) may associate an advertisement modification credit (e.g., +1 credit) with the user profile of the user who provided the action relating to game play in the interactive gaming environment associated with advertisement 934 (FIG. 9).

At step 1208, user advertisement modification information is updated. For example, one user advertisement modification credit may be stored in user action server 116 (e.g., +1 credit for a previous user action associated with advertisement 932 shown in FIG. 9). In response to the correct answer received at step 1108 shown in FIG. 11, user action server 116 updates the number of user advertisement modification credits to two credits (e.g., +1 credit for a user action associated with advertisement 934 (FIG. 9), where advertisements 932 and 934 are sponsored by the same advertiser).

At step 1210, a determination is made regarding whether or not the number of user advertisement modification credits is equal to or greater than a threshold value. For example, outside provider processor 113 (FIG. 1) may compare the number of user advertisement modification credits to an advertisement modification credit threshold value (e.g., a predetermined number of advertisement modification credits required to modify the display of an advertisement and/or future advertisements). If the comparison is not favorable (e.g., the user advertisement modification credits are less than the advertisement modification credit threshold), the process proceeds to step 1204. If the comparison is favorable (e.g., the user advertisement modification credits are equal to or greater than the advertisement modification credit threshold), process 1200 proceeds to step 1114 shown in FIG. 11 and ends.

The above described embodiments of the present disclosure are presented for purposes of illustration and not of limitation, and the present disclosure is limited only by the claims which follow.

1. A method for selectively providing supplementary media content to fill a specified time of programming, the method comprising:
receiving, on a first channel, a program comprising program segments, and supplementary media content;
receiving, on a second channel, advertisements associated with the program;
determining whether an advertisement suppression feature is enabled or disabled;
in response to determining that the advertisement suppression feature is enabled, sequentially displaying the program segments and the supplementary media content; and
in response to determining that the advertisement suppression feature is disabled, sequentially displaying the program segments and the advertisements.

2. The method of claim 1, wherein the supplementary media content comprises one or more of premium media content, a pay-per-view media asset, a video on-demand media asset, a Digital Video Disc extra, an interview, a “making of” media asset, television programming, Internet content, an article, an image, and a combination thereof.

3. The method of claim 1, wherein receiving the advertisements comprises receiving one or more advertisements respectively scheduled for display before or after one or more of the program segments.

4. The method of claim 1, wherein receiving the advertisements comprises receiving, on the second channel, a multiplexed signal comprising the advertisements associated with the program and a plurality of additional advertisements associated with a plurality of additional programs.

5. The method of claim 1, wherein the program is a first program, wherein the advertisements are first advertisements, further comprising:
receiving, on the second channel, second advertisements associated with a second program; and
in response to determining that the advertisement suppression feature is disabled, sequentially displaying the program segments and the first advertisements.

6. The method of claim 5, wherein receiving the first advertisements and the second advertisements comprises receiving, on the second channel, a multiplexed signal comprising the first advertisements and the second advertisements.

7. The method of claim 1, wherein determining whether the advertisement suppression feature is enabled or disabled comprises determining whether the user is subscribed to an advertisement suppression service.

8. The method of claim 1, wherein sequentially displaying the program segments and the supplementary media content comprises tuning to the first channel.

9. The method of claim 1, wherein sequentially displaying the program segments and the advertisements comprises:
automatically tuning to the first channel to display each of the program segments, and
automatically tuning to the second channel to display each of the advertisements.

10. The method of claim 1, further comprising:
recording one or more of the program segments on an electronic storage device; and
recording one or more of the advertisements on an electronic storage device,
wherein sequentially displaying the program segments and the advertisements comprises:
displaying each of the program segments by one of automatically tuning to the first channel, and playing the program segment stored on the electronic storage device; and
displaying each of the advertisements by one of automatically tuning to the second channel, and playing an advertisement stored on the electronic storage device.

11. A system for selectively providing supplementary media content to fill a specified time of programming, the system comprising electronic processing equipment configured to:
receive, on a first channel, a program comprising program segments, and supplementary media content;
receive, on a second channel, advertisements associated with the program;
determine whether an advertisement suppression feature is enabled or disabled;
in response to determining that the advertisement suppression feature is enabled, sequentially display the program segments and the supplementary media content; and
in response to determining that the advertisement suppression feature is disabled, sequentially display the program segments and the advertisements.

12. The system of claim 11, wherein the supplementary media content comprises one or more of premium media content, a pay-per-view media asset, a video on-demand media asset, a Digital Video Disc extra, an interview, a “making of” media asset, television programming, Internet content, an article, an image, and a combination thereof.

13. The system of claim 11, wherein each of the advertisements is scheduled for display before or after a respective program segment.

14. The system of claim 11, wherein the electronic processing equipment is further configured to receive, on the second channel, a multiplexed signal comprising the advertisements associated with the program and a plurality of additional advertisements associated with a plurality of additional programs.

15. The system of claim 11, wherein the program is a first program, wherein the advertisements are first advertisements, and wherein the electronic processing equipment is further configured to:
receive, on the second channel, second advertisements associated with a second program; and
in response to determining that the advertisement suppression feature is disabled, sequentially display the program segments and the first advertisements.

16. The system of claim 15, wherein the electronic processing equipment is further configured to receive, on the second channel, a multiplexed signal comprising the first advertisements and the second advertisements.

17. The system of claim 11, wherein the electronic processing equipment is further configured to determine whether the advertisement suppression feature is enabled or disabled by determining whether the user is subscribed to an advertisement suppression service.

18. The system of claim 11, wherein the electronic processing equipment is further configured to sequentially display the program segments and the supplementary media content by tuning to the first channel.

19. The system of claim 11, wherein the electronic processing equipment is further configured:
automatically tuning to the first channel to display each of the program segments, and
automatically tuning to the second channel to display each of the advertisements.

20. The system of claim 11, further comprising an electronic storage device coupled to the electronic processing equipment, wherein the electronic processing equipment is further configured to:
record one or more of the program segments on the electronic storage device;
record one or more of the advertisements on the electronic storage device;
display each of the program segments by one of automatically tuning to the first channel, and playing the program segment stored on the electronic storage device; and
display each of the advertisements by one of automatically tuning to the second channel, and playing an advertisement stored on the electronic storage device.

21-30. (canceled)
